(19) United States
(12) Patent Application Publication
(10) Pub. No.: US 2025/0208625 A1
(43) Pub. Date: Jun. 26, 2025

(54) ATTITUDE PLANNER-CONTAINING TRAJECTORY TRACKING CONTROL METHOD AND SYSTEM FOR QUADROTOR UNMANNED AERIAL VEHICLE (UAV)

(71) Applicant: YANTAI UNIVERSITY, YANTAI CITY (CN)

(72) Inventors: ZHAOJING WU, YANTAI CITY (CN); DIANFENG ZHANG, YANTAI CITY (CN); LIKANG FENG, YANTAI CITY (CN)

(21) Appl. No.: 18/973,460

(22) Filed: Dec. 9, 2024

(30) Foreign Application Priority Data
Dec. 21, 2023 (CN) 202311771234.1

(51) Int. Cl. G05D 1/49; G05D 109/25

(52) U.S. Cl. CPC G05D 1/49; G05D 2109/254

(57) ABSTRACT

Provided are an attitude planner-containing trajectory tracking control method and system for a quadrotor unmanned aerial vehicle (UAV). The attitude planner-containing trajectory tracking control method for a quadrotor UAV includes: acquiring a barycentric coordinate, a yaw angle, a pitch angle, a roll angle, a linear velocity along a coordinate direction, and an angular velocity of a corresponding turning angle of the quadrotor UAV in real time; calculating a quaternion-based quadrotor UAV dynamic model; constructing a smooth attitude planner; calculating an attitude error dynamic system model of the quadrotor UAV according to a planned attitude angular velocity with a Rodrigues parameter; in combination with a position dynamic system model and the attitude error dynamic system model based on the Rodrigues parameter, constructing an outer-loop trajectory tracking control module and an inner-loop attitude control module with a hierarchical control technology; obtaining an attitude planner-containing trajectory tracking control result for the quadrotor UAV.

### CROSS REFERENCE TO RELATED APPLICATION

This patent application claims the benefit and priority of Chinese Patent Application No. 2023117712341, filed with the China National Intellectual Property Administration on Dec. 21, 2023, the disclosure of which is incorporated by reference herein in its entirety as part of the present application.

### TECHNICAL FIELD

The present disclosure relates to the technical field of unmanned aerial vehicle (UAV) control, and in particular to an attitude planner-containing trajectory tracking control method and system for a quadrotor UAV.

### BACKGROUND

The quadrotor UAV is an underactuated system because it has six degrees of freedom (DOFs) but only four inputs. Due to topological obstruction, it is a great challenge to control the quadrotor UAV That is, the attitude of the mechanical system having a rotational DOF cannot be globally stabilized through continuous feedback. A variety of control technologies based on different attitude descriptions, mainly including a Euler angle-based attitude controller, a rotation matrix-based attitude controller, and a quaternion-based attitude controller, are proposed for the quadrotor UAV.

With the minimum three dimensions, easily-measured Euler angle design, and intuitive physical significance, the Euler angle-based attitude controller has been widely used in system modeling and control of such devices with rotary joints as industrial robots, aircrafts, vehicles, and ships. However, the Euler angle-based attitude controller is mainly defective for a lockup problem at a particular position and cannot realize global control. Specifically, the universal joint of the gyroscope is stuck, and cannot cause a limited amount of movement within infinitely short time.

The rotation matrix is an attitude description without a singular point. The rotation matrix-based attitude controller can overcome the lockup problem. However, due to 3*3 dimensions of the rotation matrix, the rotation matrix-based attitude controller has the redundant calculation, and is rarely used in large computational simulation for a high storage cost. On the other hand, the rotation matrix belongs to a special three-order orthogonal group, and is incompressible to any Euclidean space. Therefore, the rotation matrix-based continuous feedback controller also cannot realize the global control.

The quaternion model-based continuous controller can overcome the problems of lockup and redundant calculation, but gives rise to the unwinding phenomenon. That is, the quaternion-based controller causes unnecessary complete rotation of the UAV. In order to overcome the unwinding problem, hybrid hysteretic control is introduced in the prior art. Hence, the quaternion-based controller is realized hardly, without desirable robustness.

### SUMMARY

An objective of the present disclosure is to provide an attitude planner-containing trajectory tracking control method for a quadrotor UAV and system, to solve the lockup (namely the universal joint of the gyroscope is stuck), the redundant calculation of the controller, and the unwinding phenomenon (namely the UAV has unnecessary complete rotation) in existing quadrotor UAV control technologies based on different attitude descriptions, and prevent the discontinuity, hybrid hysteretic control and other problems caused in the process of overcoming the unwinding phenomenon.

To achieve the above objective, the present disclosure provides the following solutions:

According to a first aspect, the present disclosure provides an attitude planner-containing trajectory tracking control method for a quadrotor UAV, including:
acquiring a historical dataset of a barycentric coordinate, a historical dataset of a yaw angle, a historical dataset of a pitch angle, a historical dataset of a roll angle, a historical dataset of a linear velocity along a coordinate direction, and a historical dataset of an angular velocity of a corresponding turning angle of the quadrotor UAV;
acquiring the barycentric coordinate, the yaw angle, the pitch angle, the roll angle, the linear velocity along the coordinate direction, and the angular velocity of the corresponding turning angle of the quadrotor UAV in real time;
performing kinematic calculation based on the historical dataset of the barycentric coordinate, the historical dataset of the yaw angle, the historical dataset of the pitch angle, the historical dataset of the roll angle, the historical dataset of the linear velocity along the coordinate direction, and the historical dataset of the angular velocity of the corresponding turning angle of the quadrotor UAV, mechanical calculation on four propellers, and mechanical calculation on a body, and calculating an attitude quaternion to obtain a quaternion-based quadrotor UAV dynamic model;
designing a desired fully-actuated force control, and calculating a main thrust direction of a body-fixed frame and a desired thrust direction of an inertial frame according to the desired fully-actuated force control to construct a relative quaternion;
constructing a smooth attitude planner based on the relative quaternion;
determining an attitude error quaternion and an angular velocity error quaternion based on the smooth attitude planner;
calculating an attitude error of the quadrotor UAV based on the attitude error quaternion and the angular velocity error quaternion with a Rodrigues parameter;
determining an outer-loop position control design result and an inner-loop attitude control design result based on the attitude error of the quadrotor UAV;
constructing an attitude planner-containing position and attitude control model for the quadrotor UAV according to the outer-loop position control design result and the inner-loop attitude control design result; and
inputting the barycentric coordinate, the yaw angle, the pitch angle, the roll angle, the linear velocity along the coordinate direction, and the angular velocity of the corresponding turning angle of the quadrotor UAV that are acquired in real time to the attitude planner-containing position and attitude control model for the quadrotor UAV, thereby obtaining an attitude planner-containing tracking control result for the quadrotor UAV.

Optionally, the quaternion-based quadrotor UAV dynamic model is expressed as:

$$\dot{r} = v$$

$$m \dot{v} = Fq ⊗ {e}_{3} ⊗ {q}^{- 1} - {mge}_{3} + {d}_{p}$$

$$\dot{q} = \frac{1}{2} q ⊗ \overline{ω}$$

$$J \dot{ω} = - ω \times J ω + τ + {d}_{a}$$

where, r=(x, y, z)^{T} and ν respectively represent a position and a velocity of the quadrotor UAV, q=(q₁, q₂, q₃, q₄)=(η, ε^{T}) represents an attitude unit quaternion calculated through an Euler angle, ηϵ□ and εϵ□³ being respectively a scalar and a vector of the quaternion, and □ representing a set of all real numbers, mϵ [symbol] represents a mass, g represents an acceleration of gravity, Fϵ□ and τ=(τₓ, τ_{y}, τ_{z})ϵ□³ respectively represent a lift force and a torque obtained by the four propellers, e₃=(0, 0, 1)^{T} ϵ□³ is a unit vector in an axis z of the inertial frame, Jϵ□³×□³ is a body-fixed inertial matrix, ωϵS²={xϵ□³|x^{T}x=1} represents a rotational angular velocity, ω=(0,ω^{T})^{T} is an angular velocity quaternion, dₚ and dₐ respectively represent an uncertain disturbance on a translation system and an uncertain disturbance on a rotation system, including a resistance and a wind turbulence, \dot{r} is a first derivative of r, \dot{ν} is a first derivative of ν, \dot{q} is a first derivative of q \dot{ω} is a first derivative of ω, and q⁻¹ is an inverse of q.

Optionally, the desired fully-actuated control is expressed as:

$${μ}_{d} = m g {e}_{3} + m {\ddot{r}}_{*} - ( {c}_{2} + \frac{8}{{d}_{1}} + {c}_{1} m ) {v}_{e} + {c}_{1}^{2} m {r}_{e}$$

where, μ_{d} represents the desired fully-actuated control, mϵ□ represents a mass, □ being a set of all real numbers, g represents an acceleration of gravity, e₃ represents a unit vector in an axis z of the inertial frame, \ddot{r}_{*} is a second derivative of r_{*}, r_{*} represents a reference trajectory, c₂,d₁ and c₁ each are a positive design parameter, rₑ represents a trajectory tracking error, and νₑ represents a translational velocity error.

Optionally, the constructing a smooth attitude planner based on the relative quaternion specifically includes the following steps:
performing quaternion square-root extraction based on the desired fully-actuated control, and performing desired attitude operation in combination with a yaw angle quaternion qv to obtain a desired attitude quaternion q_{d};
performing attitude error operation on a real-time attitude quaternion q and the desired attitude quaternion q_{d} to obtain an attitude error quaternion qₑ and a Rodrigues parameter attitude error ρₑ;
performing desired attitude derivation on the desired attitude quaternion q_{d}, and performing angular velocity error calculation in combination with the attitude error quaternion qₑ and a real-time rotational angular velocity ω to obtain a rotational angular velocity error ωₑ and transformation data ωₚ of a desired rotational angular velocity ω_{d}; and
performing rotation matrix calculation on the attitude quaternion q to obtain a rotation matrix R.

Optionally, the inner-loop attitude control design result is expressed as:

$$τ = - {c}_{4} {ω}_{z} + J ( {\dot{ω}}_{α} + {\dot{ω}}_{p} ) + ω \times J ω - {Φ}^{T} {ρ}_{e}$$

where, c₄ represents a positive design parameter, ω_{z} represents an angular velocity error, J represents a body-fixed inertial matrix, ω_{α} represents a first derivative of an angular velocity stabilization function, \dot{ω}ₚ represents a first derivative of a desired angular velocity based on a quaternion description, ω represents an angular velocity, Φ^{T} represents a rotation matrix based on the Rodrigues parameter, and ρₑ represents an attitude error based on the Rodrigues parameter.

According to a second aspect, based on the above method in the present disclosure, the present disclosure further provides an attitude planner-containing trajectory tracking control system for a quadrotor UAV, including:
a first dataset acquisition module configured to acquire a historical dataset of a barycentric coordinate, a historical dataset of a yaw angle, a historical dataset of a pitch angle, a historical dataset of a roll angle, a historical dataset of a linear velocity along a coordinate direction, and a historical dataset of an angular velocity of a corresponding turning angle of the quadrotor UAV;
a second dataset acquisition module configured to acquire the barycentric coordinate, the yaw angle, the pitch angle, the roll angle, the linear velocity along the coordinate direction, and the angular velocity of the corresponding turning angle of the quadrotor UAV in real time;
a quaternion-based quadrotor UAV dynamic model construction module configured to perform kinematic calculation based on the historical dataset of the barycentric coordinate, the historical dataset of the yaw angle, the historical dataset of the pitch angle, the historical dataset of the roll angle, the historical dataset of the linear velocity along the coordinate direction, and the historical dataset of the angular velocity of the corresponding turning angle of the quadrotor UAV, mechanical calculation on four propellers, and mechanical calculation on a body, and calculate an attitude quaternion to obtain a quaternion-based quadrotor UAV dynamic model;
a relative quaternion construction module configured to design a desired fully-actuated force control, and calculate a main thrust direction of a body-fixed frame and a desired thrust direction of an inertial frame according to the desired fully-actuated force control to construct a relative quaternion;
a smooth attitude planner construction module configured to construct a smooth attitude planner based on the relative quaternion;
an attitude error quaternion and angular velocity error quaternion determining module configured to determine an attitude error quaternion and an angular velocity error quaternion based on the smooth attitude planner;
a quadrotor UAV attitude error calculation module configured to calculate an attitude error of the quadrotor UAV based on the attitude error quaternion and the angular velocity error quaternion with a Rodrigues parameter;
an outer-loop design result and an inner-loop design result determining module configured to determine an outer-loop position control design result and an inner-loop attitude control design result based on the attitude error of the quadrotor UAV;
a quadrotor UAV position and attitude control model construction module configured to construct an attitude planner-containing position and attitude control model for the quadrotor UAV according to the outer-loop position control design result and the inner-loop attitude control design result; and
a tracking control result determining module configured to input the barycentric coordinate, the yaw angle, the pitch angle, the roll angle, the linear velocity along the coordinate direction, and the angular velocity of the corresponding turning angle of the quadrotor UAV that are acquired in real time to the attitude planner-containing position and attitude control model for the quadrotor UAV, thereby obtaining an attitude planner-containing tracking control result for the quadrotor UAV.

Optionally, the quaternion-based quadrotor UAV dynamic model is expressed as:

$$\dot{r} = v$$

$$m \dot{v} = Fq ⊗ {e}_{3} ⊗ {q}^{- 1} - {mge}_{3} + {d}_{p}$$

$$\dot{q} = \frac{1}{2} q ⊗ \overline{ω}$$

$$J \dot{ω} = - ω \times J ω + τ + {d}_{a}$$

where, r=(x, y, z)^{T} and ν respectively represent a position and a velocity of the quadrotor UAV, represents an attitude unit quaternion calculated through an Euler angle, q=(q₁, q₂, q₃, q₄)=(η,ε^{T}) being respectively a scalar and a vector of the quaternion, and □ representing a set of all real numbers, mϵ□ represents a mass, g represents an acceleration of gravity, Fϵ [symbol] and τ=(τₓ, τ_{y}, τ_{z})^{T} ϵ□³ respectively represent a lift force and a torque obtained by the four propellers, e₃=(0, 0, 1)^{T} is a unit vector in an axis z of the inertial frame, Jϵ□³×□³ is a body-fixed inertial matrix, ωϵS² {xϵ□³|x^{T}x=1} represents a rotational angular velocity, ω̅=(0,ωT)^{T} is an angular velocity quaternion, dₚ and dₐ respectively represent an uncertain disturbance on a translation system and an uncertain disturbance on a rotation system, including a resistance and a wind turbulence, \dot{r} is a first derivative of r, \dot{ν} is a first derivative of ν, \dot{q} is a first derivative of q, \dot{ω} is a first derivative of ω, and q⁻¹ is an inverse of q.

Optionally, the desired fully-actuated control is expressed as:

$${μ}_{d} = m g {e}_{3} + m {\ddot{r}}_{*} - ( {c}_{2} + \frac{8}{{d}_{1}} + {c}_{1} m ) {v}_{e} + {c}_{1}^{2} m {r}_{e}$$

where, μ_{d} represents the desired fully-actuated control, mϵ□ represents a mass, □ being a set of all real numbers, g represents an acceleration of gravity, e₃ represents a unit vector in an axis z of the inertial frame, \ddot{r}_{*} is a second derivative of r_{*}, r_{*} represents a reference trajectory, c₂, d₁ and c₁ each are a positive design parameter, rₑ represents a trajectory tracking error, and νₑ represents a translational velocity error.

According to a third aspect, the present disclosure provides an electronic device, including a memory and a processor, where the memory is configured to store a computer program, and the processor is configured to run the computer program to enable the electronic device to execute the attitude planner-containing trajectory tracking control method for a quadrotor UAV.

According to a fourth aspect, the present disclosure provides a computer-readable storage medium, where the computer-readable storage medium stores a computer program, and the computer program is executed by a processor to realize the attitude planner-containing trajectory tracking control method for a quadrotor UAV

According to specific embodiments provided in the present disclosure, the present disclosure has the following technical effects:

In the present disclosure, by introducing fictitious force control to convert a dynamic model at an underactuated position of the quadrotor UAV into a fully-actuated form, the Brockett constraints are prevented, and thus continuous main thrust control can be designed. Compared with the existing hybrid control, the present disclosure has easy implementation, high control accuracy, and stronger robustness.

The present disclosure makes use of the Rodrigues parameter first to design the smooth attitude planner, converts the singular equilibrium points±1 (one is stable, the other is unstable, and both represent a same attitude) in the unwinding problem caused by the quaternion-based attitude description into the singular point at infinity and the equilibrium point at an origin of coordinates in the attitude dynamic system described based on the Rodrigues vector, and can design the smooth or continuous feedback torque controller with a typical backstepping method. This effectively prevents the unwinding problem and the introduction of the hybrid control, and achieves better maneuverability.

In addition, since the attitude system based on the Rodrigues vector is converted from the quaternion, influences from angle drift are alleviated with normalization of the quaternion, and the designed torque controller can also effectively prevent the redundant calculation, thereby improving the actual applicability.

Since the outer-loop position control design result (position controller) and the inner-loop attitude control design result (attitude controller) are achieved with the typical backstepping method, the controllers are easily combined with an adaptive observer. This can solve the more complicated control problem to improve the control accuracy of the quadrotor UAV.

### BRIEF DESCRIPTION OF THE DRAWINGS

To describe the technical solutions in embodiments of the present disclosure or in the prior art more clearly, the accompanying drawings required in the embodiments are briefly described below. Apparently, the accompanying drawings in the following description show merely some embodiments of the present disclosure, and other drawings can still be derived from these accompanying drawings by those of ordinary skill in the art without creative efforts.

FIG. 1 is a flowchart of an attitude planner-containing trajectory tracking control method for a quadrotor UAV according to the present disclosure;

FIG. 2 is a coordinate frame and a schematic structural view of a quadrotor UAV according to the present disclosure;

FIG. 3 is a schematic structural view of a position and attitude dynamic model calculation module according to the present disclosure;

FIG. 4 is a structural view of an outer-loop control module according to the present disclosure;

FIG. 5 is a schematic structural view of an attitude planner module according to the present disclosure;

FIG. 6 is a schematic structural view of an inner-loop attitude control module according to the present disclosure;

FIG. 7 illustrates a control result experiment display module according to the present disclosure;

FIG. 8 is a structural view of an attitude planner-containing trajectory tracking control for a quadrotor UAV according to the present disclosure;

FIGS. 9A-9F illustrate simulation results of a quadrotor UAV in a low-altitude flight experiment without a disturbance according to the present disclosure: FIG. 9A illustrates a simulation result on x, x_{*}, FIG. 9B illustrates a simulation result on y, y_{*}, FIG. 9C illustrates a simulation result on z, z_{*}, FIG. 9D illustrates a simulation result on an attitude error ρₑ based on a Rodrigues parameter, FIG. 9E illustrates a simulation result on a lift force F, and FIG. 9F illustrates a simulation result on a torque control τ;

FIG. 10A illustrates a simulation result of a quadrotor UAV in an initial stage of a low-altitude flight experiment without a disturbance according to the present disclosure;

FIG. 10B illustrates a complete flight trajectory of a quadrotor UAV in a low-altitude flight experiment without a disturbance according to the present disclosure;

FIGS. 11A-11B are schematic view of a quadrotor UAV in a take-off stage of a low-altitude flight in a three-dimensional (3D) virtual city according to the present disclosure;

FIGS. 12A-12B are schematic view of a quadrotor UAV in an ascending stage of a low-altitude flight in a 3D virtual city according to the present disclosure;

FIGS. 13A-13B are schematic view of a quadrotor UAV in a cruising stage of a low-altitude flight in a 3D virtual city according to the present disclosure;

FIGS. 14A-14B are schematic view of a quadrotor UAV in a descending stage of a low-altitude flight in a 3D virtual city according to the present disclosure;

FIGS. 15A-15B are schematic view of a quadrotor UAV in a landing stage of a low-altitude flight in a 3D virtual city according to the present disclosure;

FIGS. 16A-16F illustrate experimental simulation results of a quadrotor UAV when there is an external disturbance according to the present disclosure: FIG. 16A illustrates a simulation result on x, x_{*}, FIG. 16B illustrates a simulation result on y, y_{*}, FIG. 16C illustrates a simulation result on z, z*, FIG. 16D illustrates a simulation result on an attitude error ρₑ based on a Rodrigues parameter, FIG. 16E illustrates a simulation result on a lift force F, and FIG. 16F illustrates a simulation result on a torque control τ;

FIGS. 17A-17F illustrate experimental simulation results when a height, a cruising radius and an external disturbance of a quadrotor UAV are doubled according to the present disclosure: FIG. 17A illustrates a simulation result on x, x_{*}, FIG. 17B illustrates a simulation result on y, y_{*}, FIG. 17C illustrates a simulation result on z, z_{*}, FIG. 17D illustrates a simulation result on an attitude error ρₑ based on a Rodrigues parameter, FIG. 17E illustrates a simulation result on a lift force F, and FIG. 17F illustrates a simulation result on a torque control τ; and

FIG. 18 is a technical route diagram according to the present disclosure.

### DETAILED DESCRIPTION OF THE EMBODIMENTS

The technical solutions in the embodiments of the present disclosure are clearly and completely described below with reference to the drawings in the embodiments of the present disclosure. Apparently, the described embodiments are merely a part rather than all of the embodiments of the present disclosure. All other embodiment obtained by a person of ordinary skill in the art based on the embodiments of the present disclosure without creative efforts shall fall within the protection scope of the present disclosure.

An objective of the present disclosure is to provide an attitude planner-containing trajectory tracking control method for a quadrotor UAV and system, to solve the lockup (namely the universal joint of the gyroscope is stuck), the redundant calculation of the controller, and the unwinding phenomenon (namely the UAV has unnecessary complete rotation) in existing quadrotor UAV control technologies based on different attitude descriptions, and prevent the discontinuity, hybrid hysteretic control and other problems caused in the process of overcoming the unwinding phenomenon.

In order to make the above objective, features and advantages of the present disclosure clearer and more comprehensible, the present disclosure will be further described in detail below in combination with accompanying drawings and specific implementations.

### Embodiment 1

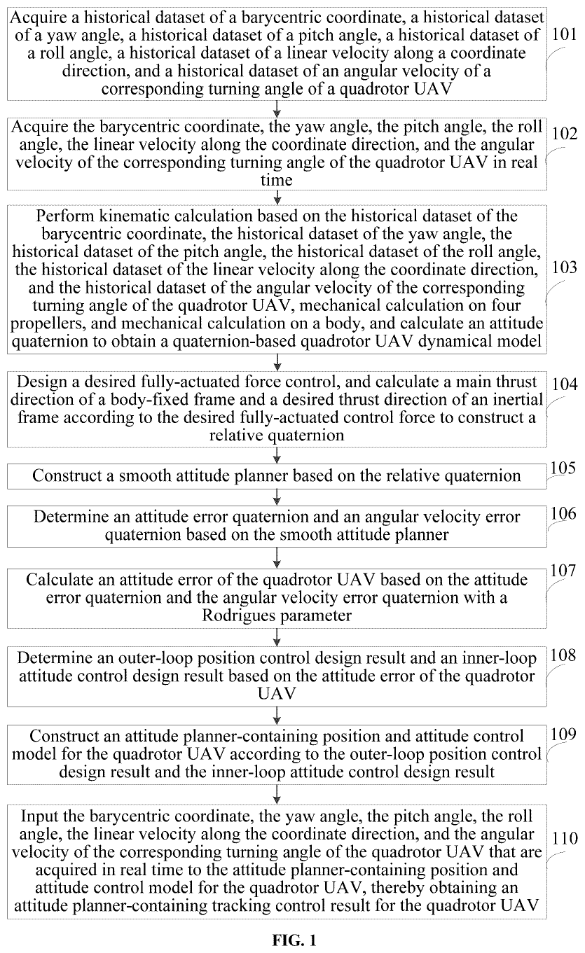

FIG. 1 is a flowchart of an attitude planner-containing trajectory tracking control method for a quadrotor UAV according to the present disclosure. As shown in FIG. 1, the method includes the following steps:

Step 101: A historical dataset of a barycentric coordinate, a historical dataset of a yaw angle, a historical dataset of a pitch angle, a historical dataset of a roll angle, a historical dataset of a linear velocity along a coordinate direction, and a historical dataset of an angular velocity of a corresponding turning angle of the quadrotor UAV are acquired.

Step 102: The barycentric coordinate, the yaw angle, the pitch angle, the roll angle, the linear velocity along the coordinate direction, and the angular velocity of the corresponding turning angle of the quadrotor UAV are acquired in real time.

Step 103: Kinematic calculation is performed on the historical dataset of the barycentric coordinate, the historical dataset of the yaw angle, the historical dataset of the pitch angle, the historical dataset of the roll angle, the historical dataset of the linear velocity along the coordinate direction, and the historical dataset of the angular velocity of the corresponding turning angle of the quadrotor UAV, mechanical calculation is performed on four propellers, mechanical calculation is performed on a body, and an attitude quaternion is calculated to obtain a quaternion-based quadrotor UAV dynamic model.

Specifically:

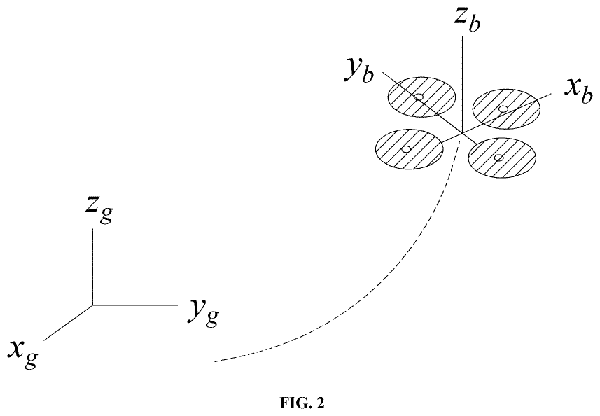

As shown in FIG. 2, FIG. 2 is a schematic view of a coordinate frame of a quadrotor UAV. The quaternion-based quadrotor UAV dynamic model is expressed as:

$$\dot{r} = v$$

$$m \dot{v} = Fq ⊗ {e}_{3} ⊗ {q}^{- 1} - {mge}_{3} + {d}_{p}$$

$$\dot{q} = \frac{1}{2} q ⊗ \overline{ω}$$

$$J \dot{ω} = - ω \times J ω + τ + {d}_{a}$$

In the foregoing equations, r=(x, y, z)^{T} and ν respectively represent a position and a velocity of the quadrotor UAV, q=(q₁, q₂, q₃, q₄)=(η, ε^{T}) represents an attitude unit quaternion calculated through an Euler angle (the yaw angle, the pitch angle, and the roll angle), ηϵ□ and εϵ³ being respectively a scalar and a vector of the quaternion, and □ representing a set of all real numbers, mϵ [symbol] represents a mass, g represents an acceleration of gravity, Fϵ□ and τ=(τₓ, τ_{y}, τ_{z})^{T}ϵ□³ respectively represent a lift force and a torque obtained by the four propellers, e₃=(0, 0, 1)^{T} is a unit vector in an axis z of the inertial frame, Jϵ□³×□³ is a body-fixed inertial matrix, ωϵS²={xϵ□³|x^{T}x=1} represents a rotational angular velocity, ω̅=(0,ω^{T})^{T} is an angular velocity quaternion, dₚ and dₐ respectively represent an uncertain disturbance on a translation system and an uncertain disturbance on a rotation system, including a resistance and a wind turbulence, \dot{r} is a first derivative of r, \dot{ν} is a first derivative of ν, \dot{q} is a first derivative of q, \dot{ω} is a first derivative of ω, and q⁻¹ is an inverse of q.

Step 104: A desired fully-actuated control is designed, and a main thrust direction of a body-fixed frame and a desired thrust direction of an inertial frame are calculated according to the desired fully-actuated force control to construct a relative quaternion.

Step 105: A smooth attitude planner is constructed based on the relative quaternion.

Step 106: An attitude error quaternion and an angular velocity error quaternion are determined based on the smooth attitude planner.

Step 107: An attitude error of the quadrotor UAV is calculated based on the attitude error quaternion and the angular velocity error quaternion with a Rodrigues parameter.

In order to solve the unwinding problem, and further design a smooth or continuous feedback controller to make the UAV realize global asymptotic tracking on a trajectory, for η≠0 a Rodrigues vector

$$ρ = \frac{ε}{η}$$

is sought. An attitude kinematic model represented by the Rodrigues vector is introduced

$$\dot{ρ} = \frac{1}{2} [ ω - ω \times ρ + ( ω \cdot ρ ) ρ ]$$

The quadrotor UAV is an underactuated system because it has six DOFs but only four inputs. Hence, only four reference output variables can be assigned arbitrarily. According to an actual demand, the reference position r=r_{*}ϵ [symbol] ³, can be assigned arbitrarily, and the yaw angle Ψ=Ψ_{*}ϵ□ is assigned as required or extracted from the trajectory.

Step 108: An outer-loop position control design result and an inner-loop attitude control design result are determined based on the attitude error of the quadrotor UAV

Step 109: An attitude planner-containing position and attitude control model for the quadrotor UAV is constructed according to the outer-loop position control design result and the inner-loop attitude control design result.

Step 110: The barycentric coordinate, the yaw angle, the pitch angle, the roll angle, the linear velocity along the coordinate direction, and the angular velocity of the corresponding turning angle of the quadrotor UAV that are acquired in real time are input to the attitude planner-containing position and attitude control model for the quadrotor UAV, thereby obtaining an attitude planner-containing tracking control result for the quadrotor UAV.

The design objectives of the present disclosure are as follows: By designing the lift force control F, the attitude torque control τ, and the attitude planner estimate Ψ=Ψ_{*}∈□, the quadrotor UAV can track a desired position signal r_{*}, and ensure that other signals of the system are bounded.

The acceleration of the UAV in descending is not greater than the acceleration of the UAV in free falling.

In order to achieve the above objectives, there are a plurality of modules in the technical solution of the present disclosure, specifically including: a dynamic model calculation module, an outer-loop control module, an attitude planner module, an inner-loop control module, a quadrotor dynamic model calculation module, and a control result experiment display module. Each module is described below in detail:

### Dynamic Model Calculation Module

This module includes a combined dynamic model calculation module, a position error dynamic model, and an attitude error dynamic model represented by the Rodrigues vector.

### 1) Combined Dynamic Model Calculation Module

The combined dynamic model calculation module is also referred to as a position and attitude dynamic model calculation module. Specifically as shown in FIG. 3, the lift force F is calculated by the outer-loop control module, R is a rotation matrix corresponding to a desired attitude calculated by the attitude planner module, τ represents a torque control calculated by the inner-loop control module, ν represents a translational velocity output by the position dynamic model calculation module, r represents a position, and ω is a rotational angular velocity obtained by the attitude dynamic model calculation module.

The dynamic model calculation module undergoes a following calculation process: The lift force F obtained by the outer-loop control module, the rotation matrix R output by the attitude planner, and the attitude q output by the attitude dynamic model calculation module are input to the position dynamic model calculation module to obtain the position r and the translational velocity ν. The torque τ output by the inner-loop control module is taken as an input signal and input to the attitude dynamic model calculation module to obtain the attitude q and the angular velocity ω.

For a desired position and a desired attitude, the position error dynamic model and the attitude error dynamic model are constructed, and a tracking control problem is converted into a stabilization problem of the error dynamic model.

### 2) Position Error Dynamic Model

For a desired position r_{*}=(x_{*}, y_{*}, z_{*})^{T}, a position error rₑ=r−r_{*} is defined, and a position error dynamic model can be obtained

$$m {\ddot{r}}_{e} = {μ}_{d} - m {\ddot{r}}_{*} - {mge}_{3} + Δ + {d}_{p}$$

In the foregoing equation, Δ=μ−μ_{d}.

### 3) Attitude Error Dynamic Model Represented by the Rodrigues Vector

The attitude error in rotation is defined as qₑ=q_{d}⁻¹ ⊗q. By calculating a derivative of the equation q_{d}⊗q_{d}⁻¹=(1, 0, 0, 0)^{T}, a derivative of an inverse element of a desired attitude quaternion is obtained

$$\begin{matrix}{\dot{q}}_{d}^{- 1} = - {q}_{d}^{- 1} ⊗ {\dot{q}}_{d} ⊗ {q}_{d}^{- 1} \\ = - {q}_{d}^{- 1} ⊗ {ω}_{d}^{I} ⊗ {q}_{d} ⊗ {q}_{d}^{- 1} \\ = - \frac{1}{2} {q}_{d}^{- 1} ⊗ {ω}_{d}^{I}\end{matrix}$$

By calculating a derivative of the attitude error qₑ, the attitude error dynamic model is obtained

$$\begin{matrix}{\dot{q}}_{e} = - {q}_{d}^{- 1} ⊗ \dot{q} + {\dot{q}}_{d}^{- 1} ⊗ q \\ = \frac{1}{2} {q}_{d}^{- 1} ⊗ {ω}^{I} ⊗ q - \frac{1}{2} {q}_{d}^{- 1} ⊗ {ω}_{d}^{I} ⊗ q \\ = \frac{1}{2} {q}_{d}^{- 1} ⊗ q ⊗ {q}^{- 1} ⊗ ( {ω}^{I} - {ω}_{d}^{I} ) ⊗ q \\ = \frac{1}{2} {q}_{e} ⊗ {ω}_{e}\end{matrix}$$

In the foregoing equation, the angular velocity error in the body-fixed frame is ωₑ=ω−ωₚ, ωₚ=qₑ⁻¹⊗ω_{d}⊗qₑ, thereby obtaining the attitude error dynamic model represented by the Rodrigues vector

$${\dot{ρ}}_{e} = \frac{1}{2} [ {ω}_{e} - {ω}_{e} \times {ρ}_{e} + ( {ω}_{e} \cdot {ρ}_{e} ) {ρ}_{e} ]$$

In combination with mechanical calculation of the quadrotor UAV, the attitude error dynamic model in the body-fixed frame is obtained

$$J {\dot{ω}}_{e} = τ - ω \times J ω - J {\dot{ω}}_{p} + {d}_{a}$$

Based on a fact that the attitude error dynamic model represented by the Rodrigues vector has a singular point at infinity and an equilibrium point at an origin O, a continuous or smooth feedback controller can be designed. This prevents the lockup and unwinding problems of the attitude error dynamic model represented by the Euler angle, the rotation matrix and the quaternion in the existing control methods, and further prevents the caused hybrid control.

### Outer-Loop Control Module

Step 1: A translational velocity error ν^{e}=\dot{r}ₑ−ν_{α}=ν−\dot{r}_{*}−ν_{α} is introduced, ν_{α} being a desired translational velocity control to be designed. A Lyapunov function of a translational displacement is defined

$${V}_{p 1} := \frac{1}{2} {r}_{e}^{T} {r}_{e}$$

According to the chain rule, a following time derivative is obtained:

$${\dot{V}}_{p 1} = {r}_{e}^{T} ( {v}_{e} + {v}_{α} )$$

In the foregoing equation, \dot{V}ₚ₁ represents a first derivative of \dot{V}ₚ₁. According to the position error dynamic model, the desired translational velocity control is designed as:

$${v}_{α} = - {c}_{1} {r}_{e} + {\dot{r}}_{*}$$

In the foregoing equation, c₁ is a positive design parameter. The derivative Vₚ₁ of the Lyapunov function Vₚ₁ is as follows:

$${\dot{V}}_{p 1} = - {c}_{1} {r}_{e}^{T} {r}_{e} + {r}_{e}^{T} {v}_{e}$$

Step 2: A derivative of the translational velocity error νₑ and a derivative of the desired translational velocity control ν_{α} are calculated to obtain a new expression of a translational position error dynamic model:

$$m {\dot{v}}_{e} = m {\ddot{r}}_{e} - m {\dot{v}}_{α} = {μ}_{d} - {mge}_{3} + {c}_{1} m ( {v}_{e} - {c}_{1} {r}_{e} ) - m {\ddot{r}}_{*} + Δ + {d}_{p}$$

In the foregoing equation, \dot{ν}ₑ is a first derivative of νₑ, \ddot{r}ₑ is a second derivative of rₑ, \dot{ν}_{α} is a first derivative of ν_{α}, \ddot{r}_{*} is a second derivative of r_{*}, and μ_{d} is a fully-actuated force control to be designed.

The Lyapunov function of a translational system is defined

$${V}_{p} := {V}_{p 1} + \frac{m}{2} {v}_{e}^{T} {v}_{e}$$

According to the chain rule, a time derivative is obtained:

$${\dot{V}}_{p} \leq - {c}_{1} {r}_{e}^{T} {r}_{e} + {r}_{e}^{T} {v}_{e} + {v}_{e}^{T} [ {μ}_{d} - {mge}_{3} + {c}_{1} m ( {v}_{e} - {c}_{1} {r}_{e} ) - m {\ddot{r}}_{*} ] + {v}_{e}^{T} Δ + {v}_{e}^{T} {d}_{p}$$

According to the Lyapunov stability theorem and the definition Δ=FR_{d} (Rₑ−I₃)e₃ of the coupling term Δ, a desired fully-actuated force control is obtained

$${μ}_{d} = {mge}_{3} + m {\ddot{r}}_{*} - ( {c}_{2} + \frac{8}{{d}_{1}} + {c}_{1} m ) {v}_{e} + {c}_{1}^{2} {mr}_{e}$$

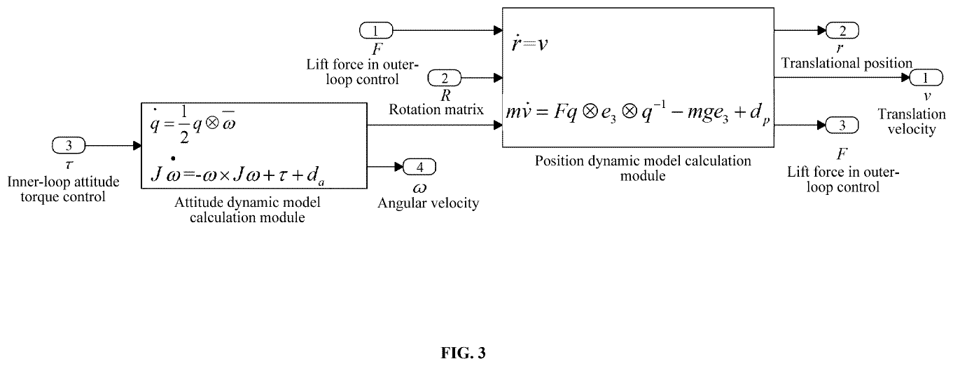

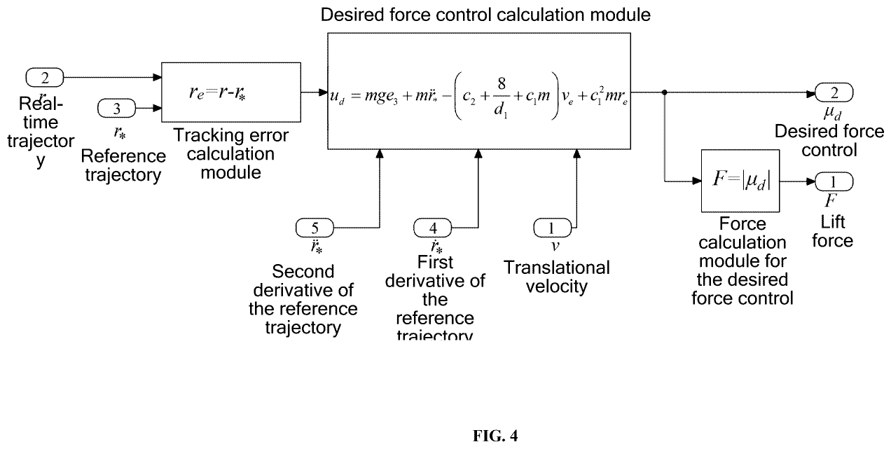

In the foregoing equation, c₂,d₁ are positive design parameters. The structural view of the outer-loop control module is as shown in FIG. 4.

Referring to FIG. 4, input signals of the outer-loop control module include: a real-time position r and a real-time translational velocity ν provided by the position dynamic model calculation module; and a reference trajectory r_{*} and a first derivative \dot{r}_{*} and a second derivative \ddot{r}_{*} of the reference trajectory. Outputs of the outer-loop control module include: a desired force control μ_{d} and a lift force F.

The outer-loop control module undergoes a following calculation process: The real-time position r and the reference trajectory r_{*} are input to a tracking error calculation module to obtain a trajectory tracking error rₑ. In combination with the translational velocity ν, and the first derivative \ddot{r}_{*} and the second derivative \ddot{r}_{*} of the reference trajectory r_{*}, the desired force control μ_{d} is obtained by a desired force control calculation module. The lift force F is obtained by a force calculation module.

### Attitude Planner Module

The desired force control vector μ_{d}ϵ□³ obtained by the outer-loop control calculation module corresponds to a desired attitude quaternion

$${q}_{d} = ( \begin{matrix}cos ( \frac{{θ}_{d}}{2} ) \\ sin ( \frac{{θ}_{d}}{2} ) {n}_{d}\end{matrix} ) ,$$

θ_{d} representing a desired rotation angle, and n_{d} representing a desired rotation axis. The desired force control satisfies

$${μ}_{d} = {Fq}_{d} ⊗ {e}_{3} ⊗ {q}_{d}^{- 1} .$$

Once the desired force control vector μ_{d} is calculated, the lift force F=|μ_{d}| can be obtained, and a direction of the desired force control μ_{d} can be obtained

$${q}_{d} ⊗ {e}_{3} ⊗ {q}_{d}^{- 1} = {\overline{μ}}_{d} .$$

After the direction of the desired force control vector μ_{d} is obtained, a desired attitude q_{d} can be solved reversely. The unit vector e₃ in the axis z of the inertial frame and the direction μ̅_{d} of the desired force control are combined into one quaternion:

$${Q}_{d} := {\overline{μ}}_{d} ⊗ {\overline{e}}_{3}^{- 1} = ( \begin{matrix}{e}_{3} \cdot {\overline{μ}}_{d} \\ {e}_{3} \times {\overline{μ}}_{d}\end{matrix} ) = {( {\overline{μ}}_{dz} , - {\overline{μ}}_{dy} , {\overline{μ}}_{dx} , 0 )}^{T}$$

With square-root operation on Q_{d}, a desired attitude quaternion q̅_{d}=(q̅_{d0}, q̅_{d1}, q̅_{d2}, q̅_{d3})^{T} can be obtained:

$${\overline{q}}_{{d}_{0}} = \sqrt{\frac{1 + {\overline{μ}}_{dz}}{2}} , {\overline{q}}_{{d}_{1}} = - \frac{{\overline{μ}}_{dy}}{2 {\overline{q}}_{{d}_{0}}} , {\overline{q}}_{d 2} = \frac{{\overline{μ}}_{dx}}{2 {\overline{q}}_{{d}_{0}}} , {\overline{q}}_{d 3} = 0.$$

The attitude quaternion

$${q}_{ψ *} = ( \begin{matrix}cos ( \frac{ψ *}{2} ) \\ sin ( \frac{ψ *}{2} ) {e}_{3}\end{matrix} )$$

defined through any assigned yaw angle Ψ* satisfies q_{Ψ}_{_{*}}⊗e₃⊗q_{Ψ}⁻¹=e₃ A desired attitude quaternion containing the yaw angle can be combined

$${q}_{d} = {\overline{q}}_{d} ⊗ {q}_{ψ *}$$

This is used as the output of the attitude planner and combined into the attitude error. By reversely solving

$${\dot{q}}_{d} = \frac{1}{2} {q}_{d} ⊗ {ω}_{d} ,$$

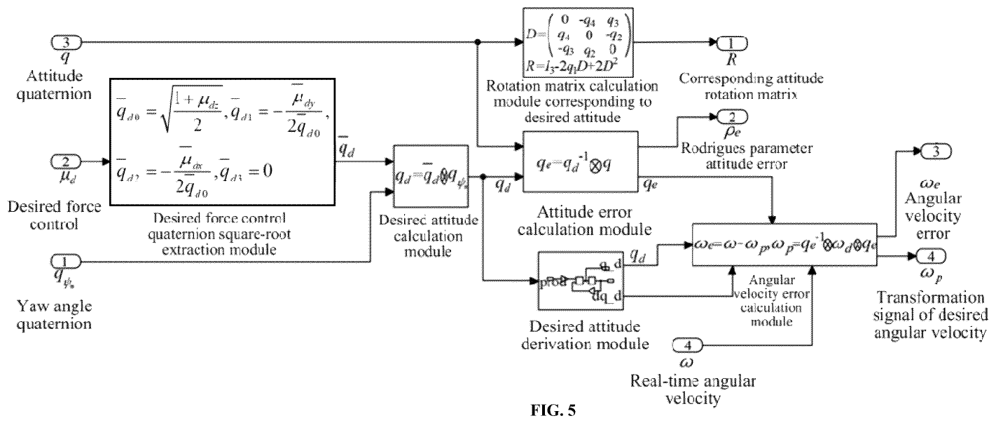

the desired angular velocity ω_{d}=2q_{d}^{-1⊗\dot{q}}_{d} is obtained, thereby completing the design of the attitude planner module. The structural view of the attitude planner is as shown in FIG. 5.

In the attitude planner module, q_{Ψ}_{_{*}} represents a yaw angle quaternion extracted from the reference trajectory, μ_{d} represents a desired external-loop force control, q represents an obtained real-time attitude quaternion, ω represents an obtained real-time rotational angular velocity, R represents a rotation matrix obtained by the attitude planner module and corresponding to the real-time attitude quaternion, ρₑ represents a Rodrigues parameter attitude error, ωₑ represents a rotational angular velocity error signal, and ωₚ represents transformation data of a desired angular velocity ω_{d}.

The attitude planner module undergoes a following calculation process: The force control μ_{d} is input to a desired attitude operation module through a quaternion square-root calculation module in combination with the yaw angle quaternion q_{Ψ}_{_{*}}to obtain the desired attitude quaternion q_{d}. The real-time attitude quaternion q and the desired attitude quaternion q_{d} are input to an attitude error operation module to obtain the attitude error quaternion qₑ and the Rodrigues parameter attitude error ρₑ. The desired attitude quaternion q_{d} is subjected to desired attitude derivation. The attitude error quaternion qₑ and the real-time rotational angular velocity ω are input to an angular velocity error module to obtain the rotational angular velocity error ωₑ and the transformation data ωₚ of the rotational angular velocity ω_{d}. The attitude quaternion q is input to a rotation matrix calculation module to obtain the rotation matrix R.

### Inner-Loop Control Module

With the Rodrigues parameter attitude error ρₑ, the rotational angular velocity error ωₑ, the ωₚ and the rotation matrix calculated by the attitude planner module, an inner-loop attitude torque controller τ is designed.

Step 1: An angular velocity error ω_{z}=ωₑ−ω_{α} is introduced, ω_{α} being a desired angular velocity control to be designed. A Lyapunov function for the attitude error based on the Rodrigues parameter is defined

Vₐ₁=ρₑ^{T}ρₑ

According to the chain rule, a time derivative is calculated by the attitude error kinematic model represented by the Rodrigues parameter:

$${\dot{V}}_{a 1} = {ρ}_{e}^{T} [ - {ω}_{α} \times {ρ}_{e} + {ω}_{α} + ( {ω}_{α} \cdot {ρ}_{e} ) {ρ}_{e} + {Φω}_{z} ]$$

In the foregoing equation,

$$Φ = \frac{1}{2} ( S ( {ρ}_{e} ) + {I}_{3} + {ρ}_{e} {ρ}_{e}^{T} ) ,$$

S(ρₑ) representing matrix operation on ρₑ, and \dot{V}ₐ₁ is a first derivative of Vₐ₁. The desired angular velocity control is designed as

$${ω}_{α} = - {c}_{3} {ρ}_{e} - ϕ$$

In the foregoing equation,

$$ϕ = \frac{{d}_{1} {ρ}_{e} {\vert F \vert}^{2}}{1 + {\vert {ρ}_{e} \vert}^{2}}$$

and c₃,d₁ are positive design parameters. The derivative \dot{V}ₚ₁ of the Lyapunov function Vₚ₁ is as follows:

$${\dot{V}}_{a 1} \leq - {c}_{3} {ρ}_{e}^{T} {ρ}_{e} + {ρ}_{e}^{T} {Φω}_{z} - {ρ}_{e}^{T} ϕ$$

Step 2: A derivative of the angular velocity error ω_{z} and a derivative of the desired angular velocity ω_{α} are calculated to obtain a new expression of the attitude error dynamic model:

$$J {\dot{ω}}_{z} = - J {\dot{ω}}_{α} + τ - ω \times J ω - J {\dot{ω}}_{p} + {d}_{a}$$

The Lyapunov function of an attitude error dynamic system is defined as

$${V}_{a} = {ρ}_{e}^{T} {ρ}_{e} + \frac{1}{2} {ω}_{z}^{T} J {ω}_{z}$$

According to the chain rule, a time derivative is obtained:

$${\dot{V}}_{a} = 2 {ρ}_{e}^{T} {\dot{ρ}}_{e} + {ω}_{z}^{T} [ τ - ω \times J ω - J ( {\dot{ω}}_{α} + {\dot{ω}}_{p} ) + {d}_{a} ]$$

According to the Lyapunov stability theorem, a desired torque control is obtained

$$τ = - {c}_{4} {ω}_{z} + J ( {\dot{ω}}_{α} + {\dot{ω}}_{p} ) + ω \times J ω - {Φ}^{T} {ρ}_{e}$$

In the foregoing equation, c₄ is a positive design parameter. The structural view of the inner-loop control module is as shown in FIG. 6.

Referring to FIG. 6, input signals of the inner-loop control module include: the desired force control μ_{d} and the lift force F output from the outer-loop control module, the reference trajectory r_{*}, and the real-time attitude quaternion q and the real-time angular velocity ω calculated by a quadrotor UAV attitude dynamic model. Output signals of the inner-loop control module include: the rotation matrix R output by the attitude planner module, and the torque control τ calculated by an inner-loop torque control module.

The inner-loop control module undergoes a following calculation process: The reference trajectory r_{*} is input to a desired yaw angle extraction module to obtain the yaw angle quaternion q_{Ψ}, which is taken as the input of the attitude planner. In combination with the desired force control μ_{d}, the attitude quaternion q and the angular velocity ω, the Rodrigues parameter attitude error ρₑ, the angular velocity error ωₑ, and ωₚ are obtained through the attitude planner module. In combination with the lift force F, the torque control τ is obtained through the inner-loop torque control calculation module.

An attitude planner-containing position and attitude control model for the quadrotor UAV is constructed according to the outer-loop force control design result and the inner-loop attitude torque control design result. The barycentric coordinate, the yaw angle, the pitch angle, the roll angle, the linear velocity along the coordinate direction, and the angular velocity of the corresponding turning angle of the quadrotor UAV are input to the attitude planner-containing position and attitude control model for the quadrotor UAV, thereby obtaining an attitude planner-containing quadrotor UAV tracking controller. Specifically:

$${v}_{α} = - {c}_{1} {r}_{e} + {\dot{r}}_{*} , {v}_{e} = v - {v}_{α} , F = \vert {μ}_{d} \vert ,$$

$${μ}_{d} = {mge}_{3} + m {\ddot{r}}_{*} - ( {c}_{2} + \frac{8}{{d}_{1}} + {c}_{1} m ) {v}_{e} + {c}_{1}^{2} {mr}_{e} ,$$

$${q}_{e} = {q}_{d}^{- 1} ⊗ q , {ω}_{d} = {q}_{d}^{- 1} ⊗ {\dot{q}}_{d} , {ω}_{e} = ω - {ω}_{p} ,$$

$${ω}_{p} = {q}_{e}^{- 1} ⊗ {ω}_{d} ⊗ {q}_{e} , {ω}_{z} = {ω}_{e} - {ω}_{α} , {ω}_{α} = - {c}_{3} {ρ}_{e} - ϕ ,$$

$$ϕ = \frac{{d}_{1} {ρ}_{e} {\vert F \vert}^{2}}{1 + {\vert {ρ}_{e} \vert}^{2}} , Φ = \frac{1}{2} ( S ( {ρ}_{e} ) + {I}_{3} + {ρ}_{e} {ρ}_{e}^{T} ) ,$$

$$τ = - {c}_{4} {ω}_{z} + J ( {\dot{ω}}_{α} + {\dot{ω}}_{p} ) + ω \times J ω - {Φ}^{T} {ρ}_{e}$$

In the foregoing equations, c₁, c₂, c₃, c₄, d₁ are positive design parameters.

### Control Result Experiment Display Module

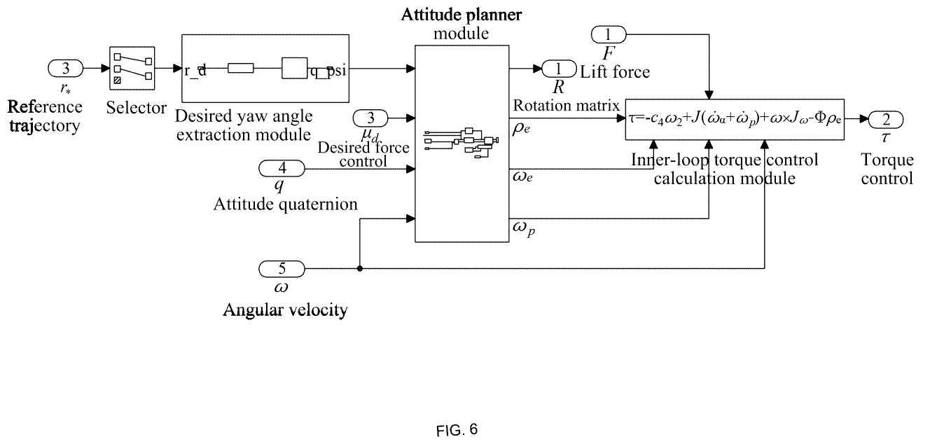

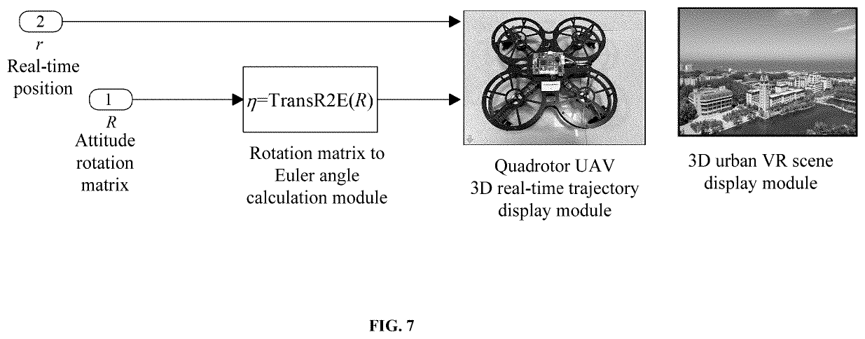

The control result experiment display module is as shown in FIG. 7. For the real-time position and the real-time attitude calculated by the closed-loop dynamic model, a 3D experimental scene display module and a real-time trajectory display module are used to show a virtual reality (VR) of the control result.

In combination with the outer-loop control module, the attitude planner module, the inner-loop control module, the quadrotor dynamic model calculation module, and the control result experiment display module, the structural view of the attitude planner-containing trajectory tracking control for a quadrotor UAV shown in FIG. 8 is obtained.

A reference trajectory signal is generated by the reference trajectory generator. In combination with real-time data of the position r and the translational velocity ν fed back by the dynamic model calculation module, the desired force control μ_{d} and the lift force F are calculated by the outer-loop control module. In combination with real-time data of the attitude q and the rotational angular velocity ω fed back by the dynamic model calculation module, the attitude rotation matrix R and the torque control τ are calculated by the inner-loop attitude control module containing the attitude planner. In combination with the desired force control μ_{d} calculated by the outer-loop control module, and the attitude rotation matrix R and the torque control τ calculated by the inner-loop attitude control module, the position and the attitude of the quadrotor UAV are controlled by the dynamic model calculation module in real time to realize asymptotic tracking on the reference trajectory. The position and the attitude of the quadrotor UAV can be displayed by the control result display module in real time.

### Performance Analysis on the Controller

The outer-loop fully-actuated force control design result and the inner-loop attitude torque control design result are calculated to construct a closed-loop error dynamic model for stability analysis. Specifically:

$$\{ \begin{matrix}{\dot{r}}_{e} = - {c}_{1} {r}_{e} + {v}_{e} , \\ m {\dot{v}}_{e} = - {c}_{2} {v}_{e} - {r}_{e} + Δ + {d}_{p} , \\ {\dot{ρ}}_{e} = \frac{1}{2} [ {ω}_{e} - {ω}_{e} \times {ρ}_{e} + ( {ω}_{e} \cdot {ρ}_{e} ) {ρ}_{e} ] , \\ J {\dot{ω}}_{z} = - {c}_{4} {ω}_{z} - {Φ}^{T} {ρ}_{e} + {d}_{a}\end{matrix}$$

A Lyapunov function of the closed-loop error dynamic model for the stability analysis is calculated to obtain an attitude planner-containing quadrotor UAV tracking control model. The barycentric coordinate, the yaw angle, the pitch angle, the roll angle, the linear velocity along the coordinate direction, and the angular velocity of the corresponding turning angle of the quadrotor UAV are input to the attitude planner-containing quadrotor UAV tracking control model to obtain the attitude planner-containing quadrotor UAV tracking controller with the following functions:

Function 1: By adjusting the design parameters, with the attitude planner-containing quadrotor UAV tracking controller, the closed-loop error dynamic model is a strictly passive system which takes external environmental noises (dₚ, dₐ) as an input and the translational velocity error and the angular velocity error (νₑ, ω_{z}) as an output.

Function 2: When the external environmental noises (dₚ, dₐ) are bounded, by introducing a damping term into the attitude planner-containing quadrotor UAV tracking controller, and adjusting the design parameters appropriately, all signals of the closed-loop system are bounded, and the output position signal r can almost realize global asymptotic tracking on r_{*}. When there is no external noise disturbance, the closed-loop system is exponentially stable, and the output position signal r can almost realize global actual tracking on r_{*}.

### Experiment

Trajectory tracking control experiments are conducted on the quadrotor UAV For different tracking tasks and different disturbance cases, same controller parameters are used to make experiments.

First case: System parameters are set as m=0.8 kg J₁=J₂=0.005 kg/m², and J₃=0.015 kg/m². An acceleration of gravity is set as g=9.8 m/s² Controller parameters are set as c₁=5,c₂=c₃=c₄=1 and d₁=1. An initial position and an initial velocity of the UAV are as follows: r₀=(r, 0, 0)^{T}, ν₀=(0,0,0)^{T}. An initial attitude and an initial angular velocity are as follows: q₀=1, ω₀=(0,0,0)^{T}. The reference trajectory is divided into an ascending stage, a cruising stage, and a descending stage. Specifically:

$${x}_{*} = r cos ( {k}_{1} t ) ,$$

$${y}_{*} = r sin ( {k}_{2} t ) ,$$

$${z}_{*} = \{ \begin{matrix}\frac{h}{2} ( 1 - cos ( \frac{π}{{T}_{1}} t ) ) , & 0 \leq t \leq {T}_{1} \\ h , & {T}_{1} \leq t \leq {T}_{2} \\ \frac{h}{2} ( 1 + cos ( \frac{π}{{T}_{1}} ( t - {T}_{2} ) ) , & {T}_{2} < t \leq T\end{matrix}$$

In the foregoing equations,

$${T}_{1} = {T}_{2} = {T}_{3} = \frac{1}{3} T ,$$

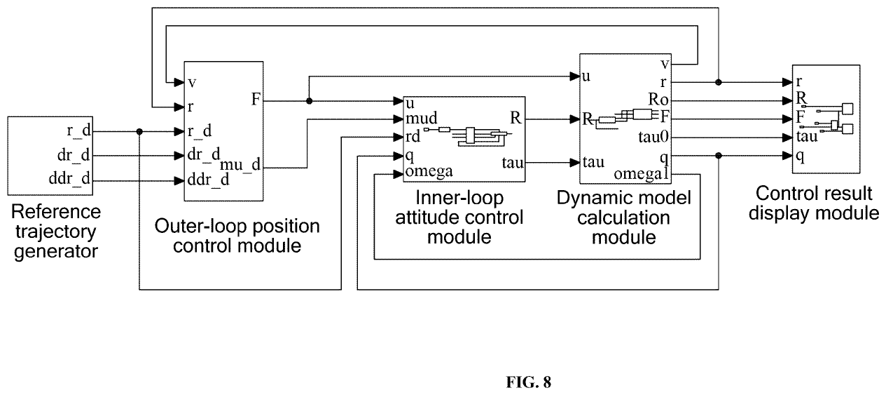

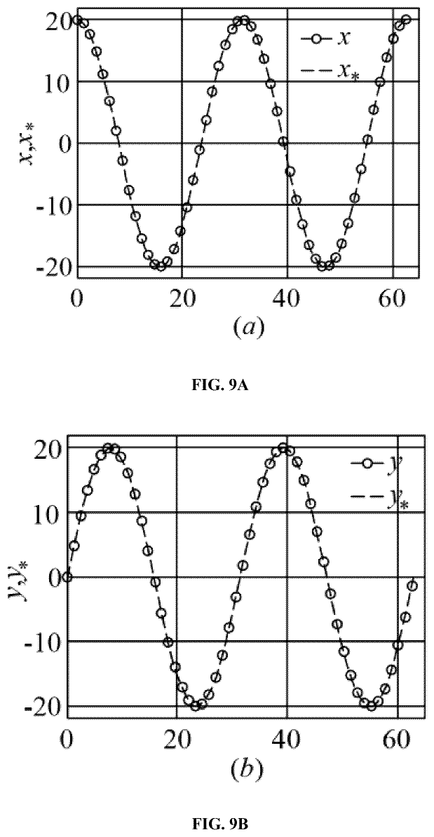

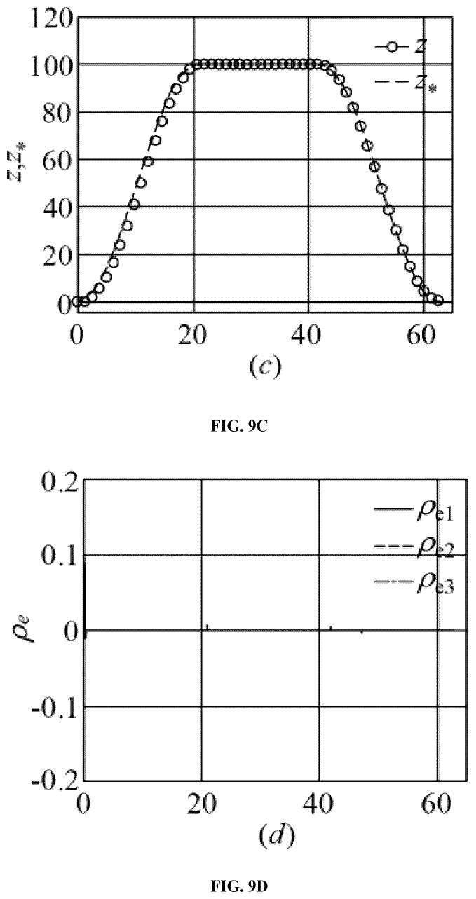

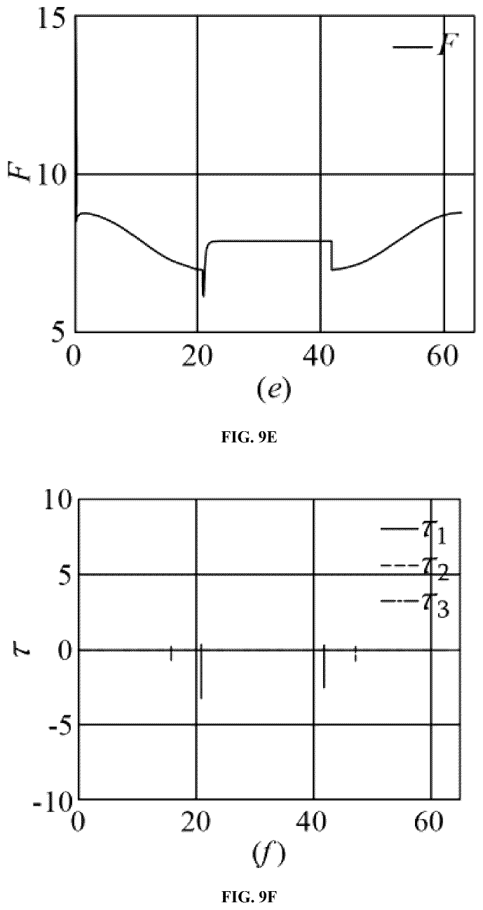

disturbance dₚ=0,dₐ=0, parameter k₁=k₂=0.2, height h=100 m, cruising radius r=20 m, and simulation time T=20 πs. Simulation results are shown in FIGS. 9A-9F.

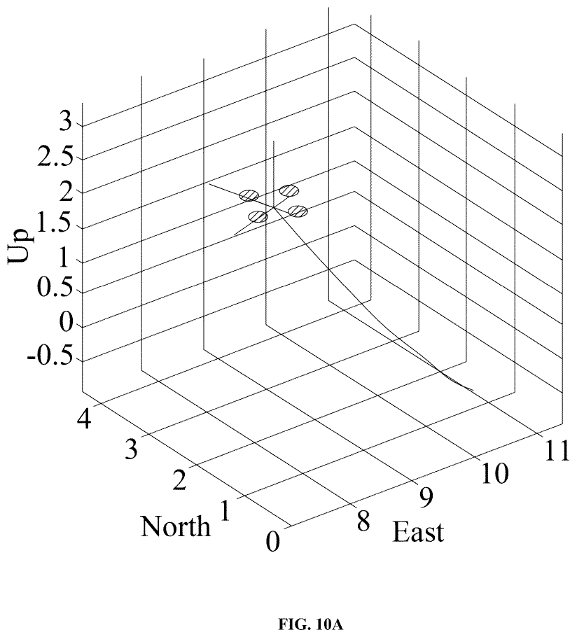

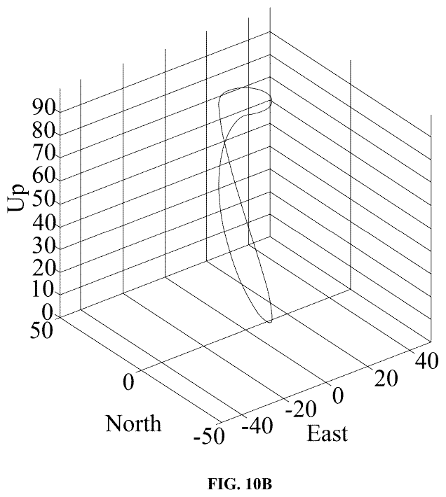

Through observation on the simulation results in FIGS. 9A-9F, the tracking error tends to zero, the attitude error tends to zero, and both the lift force and the torque are saturated. The 3D graph of the flight route is shown in FIGS. 10A-10B. As can be seen from the 3G graph in the initial stage, the X axis (horizontal straight line) in the body-fixed frame of the UAV is along a tangential direction of projection of the trajectory in the XY plane. As can be seen from the complete flight route, the UAV can go back to the starting point accurately, with a head pointing to a take-off direction.

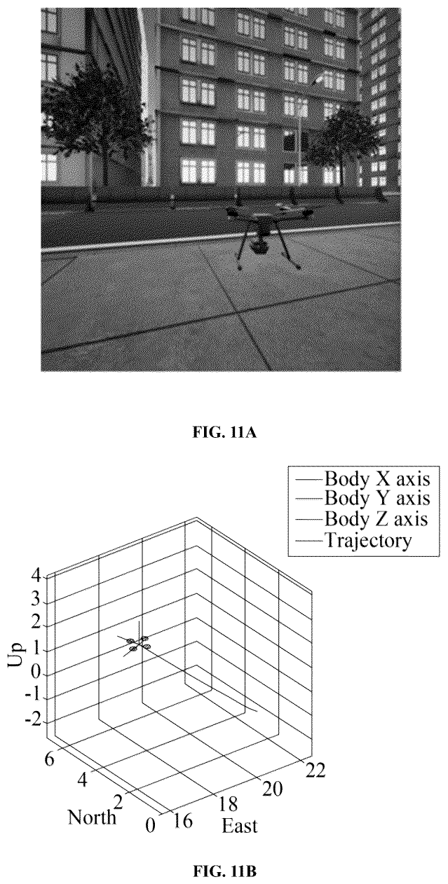

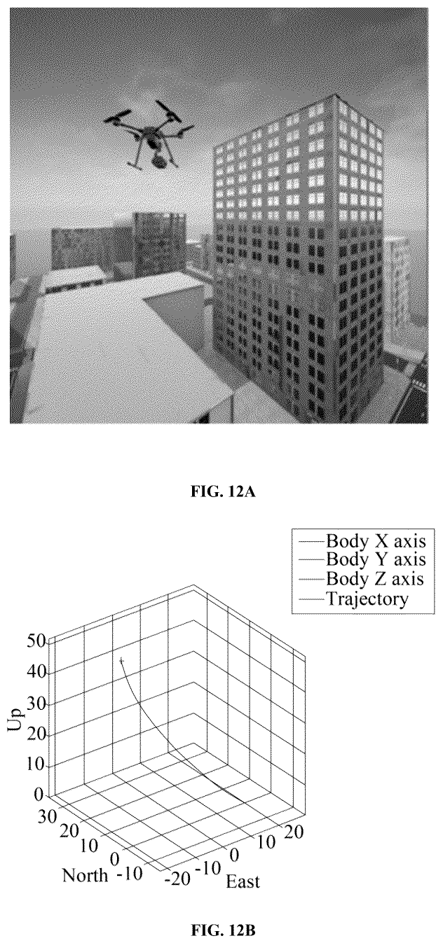

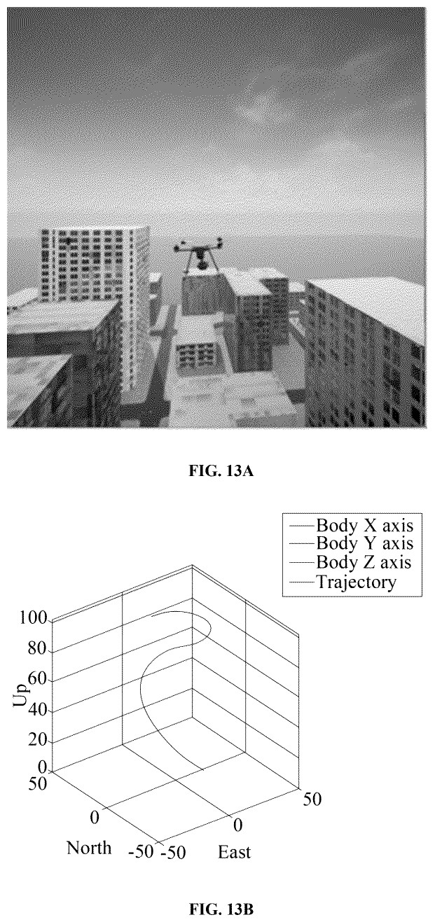

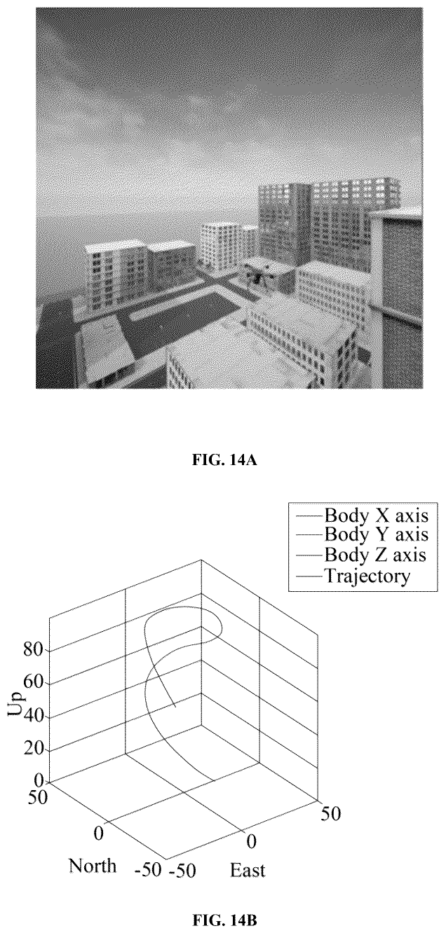

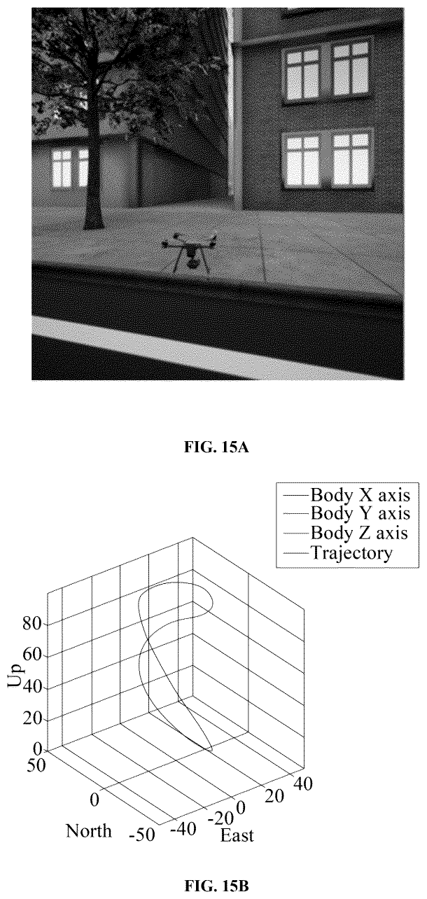

FIGS. 11A-11B to FIGS. 15A-15B illustrate a complete flight process of the quadrotor UAV, including a take-off stage, an ascending stage, a cruising stage, a descending stage, and a landing stage.

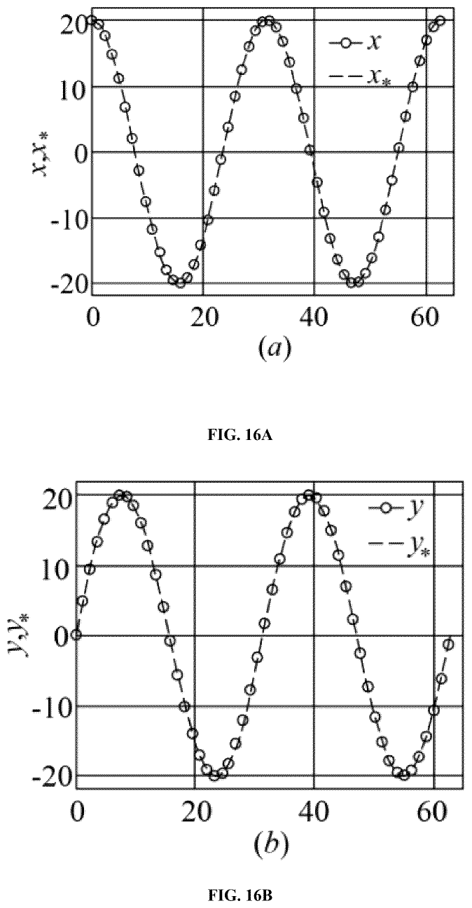

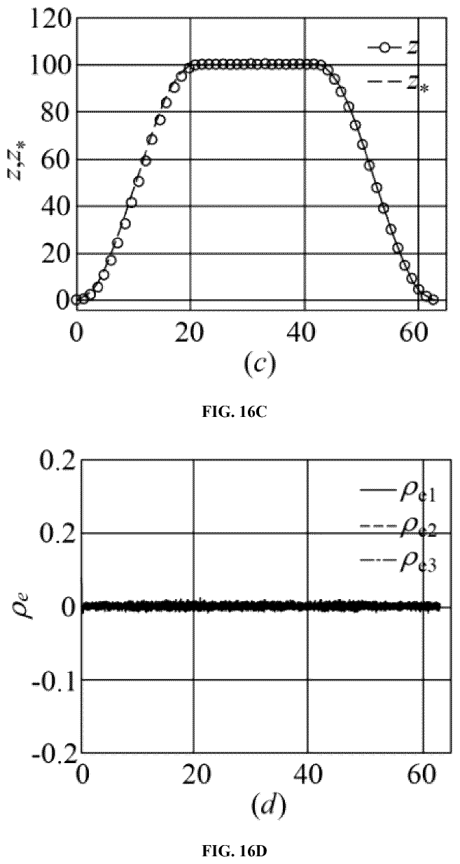

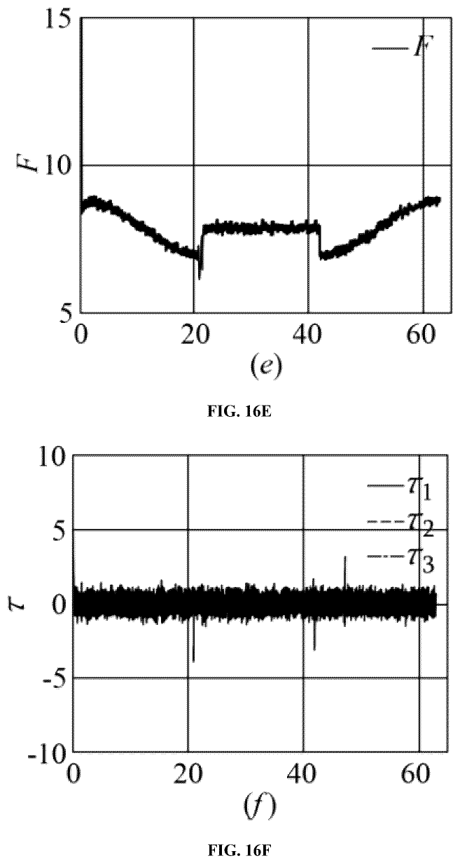

Second case: Disturbances dₚ=0.1 W₁, dₐ=0.1 W₂, W₁ and W₂ are unit white noises, and other parameters are the same as those in the first case. Simulation results are shown in FIGS. 16A-16F. When there is an external disturbance, the controller still can realize the actual tracking task, which is hardly distinguished from asymptotic tracking. The designed tracking controller has strong disturbance resistance.

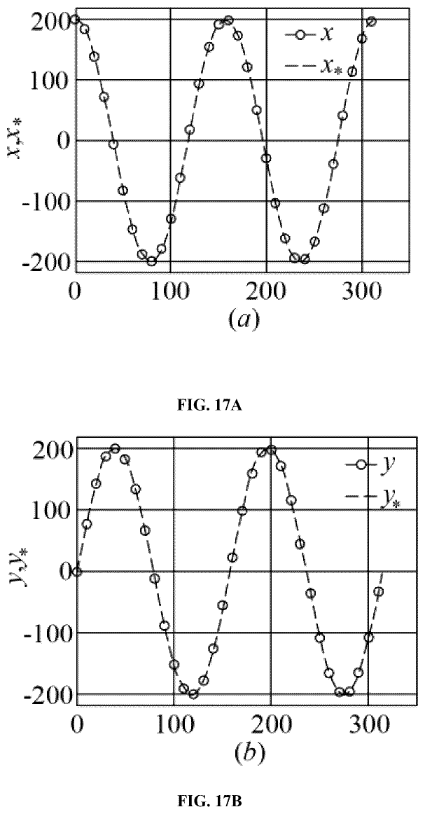

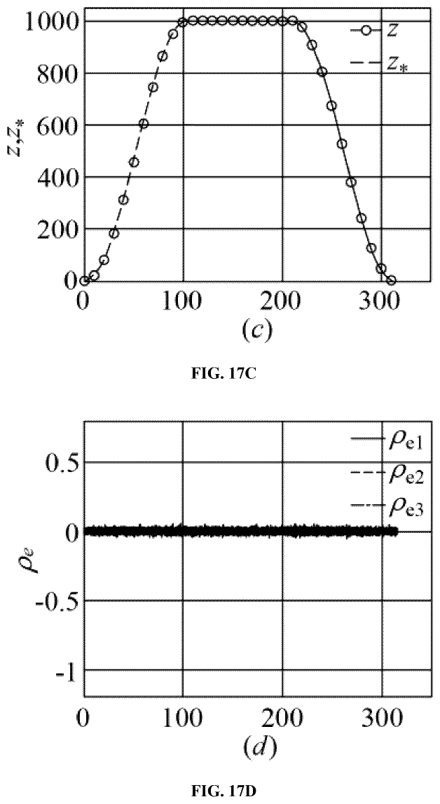

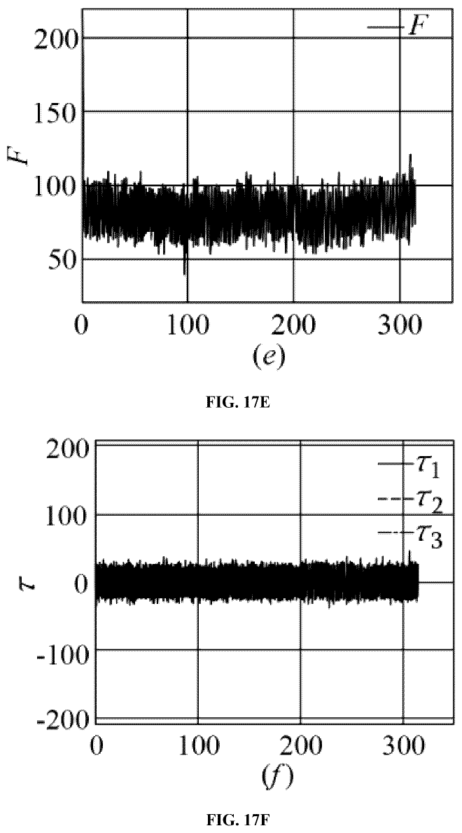

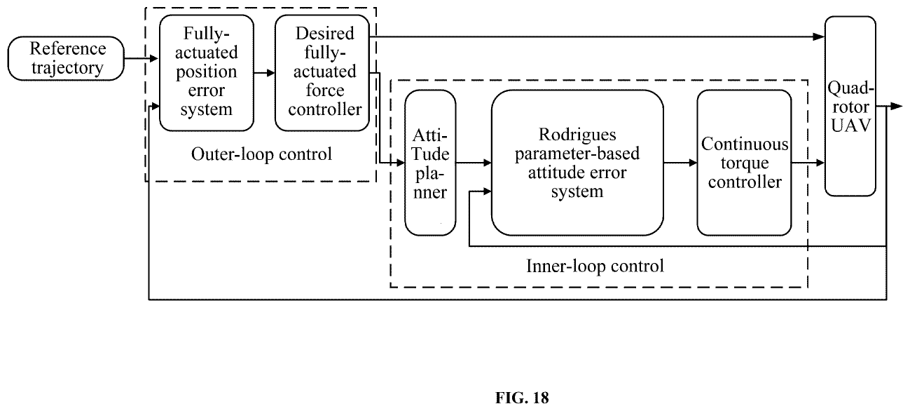

Third case: System parameters are set as m=8 kg J₁=J₂=0.05 kg/m₂, and J₃=0.15 kg/m² In the controller parameters, d₁=0.1, disturbance dₚ=W₁, dₐ=W₂, which is 10 times that in the second case, parameter k₁=k₂=0.04, height h=1000 m, cruising radius r=200 m, and simulation time T=100π s. Other parameters are the same as those in the first case. Simulation results are shown in FIGS. 17A-17F. Compared with the first case and the second case, the mass and the moment of inertia are increased to 10 times, the flight height and the flight radius are expanded to 10 times, and the flight time is prolonged to 5 times. This indicates that the control solution can be suitable for different tracking tasks, and can still achieve the desirable tracking effect in case of increased external disturbances. Therefore, the control method has strong robustness.

To sum up, the technical solution in the present disclosure has the following beneficial effects:

In the embodiments of the present disclosure, by introducing fictitious force control to convert a dynamic model at an underactuated position of the quadrotor UAV into a fully-actuated form, the Brockett constraints are prevented, and thus continuous main thrust control can be designed. Compared with the existing hybrid control, the present disclosure has easy implementation, high control accuracy, and stronger robustness.

The present disclosure makes use of the Rodrigues parameter first to design the smooth attitude planner, converts the singular equilibrium points±1 (one is stable, the other is unstable, and both represent a same attitude) in the unwinding problem caused by the quaternion-based attitude description into the singular point at infinity and the equilibrium point at an origin of coordinates in the attitude dynamic system described based on the Rodrigues vector, and can design the smooth or continuous feedback torque controller with a typical backstepping method. This effectively prevents the unwinding problem and the introduction of the hybrid control, and achieves better maneuverability.

In addition, since the attitude system based on the Rodrigues vector is converted from the quaternion, influences from angle drift are alleviated with normalization of the quaternion, and the designed torque controller can also effectively prevent the redundant calculation, thereby improving the actual applicability.

Since the outer-loop position control design result (position controller) and the inner-loop attitude control design result (attitude controller) are achieved with the typical backstepping method, the controllers are easily combined with an adaptive observer. This can solve the more complicated control problem to improve the control accuracy of the quadrotor UAV.

### Embodiment 2

To implement the corresponding method in Embodiment 1 and achieve corresponding functions and technical effects, an attitude planner-containing trajectory tracking control system for a quadrotor UAV is provided below, including: a first dataset acquisition module, a second dataset acquisition module, a quaternion-based quadrotor UAV dynamic model construction module, a relative quaternion construction module, a smooth attitude planner construction module, an attitude error quaternion and angular velocity error quaternion determining module, a quadrotor UAV attitude error calculation module, an outer-loop design result and an inner-loop design result determining module, a quadrotor UAV position and attitude control model construction module, and a tracking control result determining module.

The first dataset acquisition module is configured to acquire a historical dataset of a barycentric coordinate, a historical dataset of a yaw angle, a historical dataset of a pitch angle, a historical dataset of a roll angle, a historical dataset of a linear velocity along a coordinate direction, and a historical dataset of an angular velocity of a corresponding turning angle of the quadrotor UAV.

The second dataset acquisition module is configured to acquire the barycentric coordinate, the yaw angle, the pitch angle, the roll angle, the linear velocity along the coordinate direction, and the angular velocity of the corresponding turning angle of the quadrotor UAV in real time.

The quaternion-based quadrotor UAV dynamic model construction module is configured to perform kinematic calculation based on the historical dataset of the barycentric coordinate, the historical dataset of the yaw angle, the historical dataset of the pitch angle, the historical dataset of the roll angle, the historical dataset of the linear velocity along the coordinate direction, and the historical dataset of the angular velocity of the corresponding turning angle of the quadrotor UAV, mechanical calculation on four propellers, and mechanical calculation on a body, and calculate an attitude quaternion to obtain a quaternion-based quadrotor UAV dynamic model.

The relative quaternion construction module is configured to design a desired fully-actuated force control, and calculate a main thrust direction of a body-fixed frame and a desired thrust direction of an inertial frame according to the desired fully-actuated force control to construct a relative quaternion.

The smooth attitude planner construction module is configured to construct a smooth attitude planner based on the relative quaternion.

The attitude error quaternion and angular velocity error quaternion determining module is configured to determine an attitude error quaternion and an angular velocity error quaternion based on the smooth attitude planner.

The quadrotor UAV attitude error calculation module is configured to calculate an attitude error of the quadrotor UAV based on the attitude error quaternion and the angular velocity error quaternion with a Rodrigues parameter.

The outer-loop design result and an inner-loop design result determining module is configured to determine an outer-loop position control design result and an inner-loop attitude control design result based on the attitude error of the quadrotor UAV.

The quadrotor UAV position and attitude control model construction module configured to construct an attitude planner-containing position and attitude control model for the quadrotor UAV according to the outer-loop position control design result and the inner-loop attitude control design result.

The tracking control result determining module is configured to input the barycentric coordinate, the yaw angle, the pitch angle, the roll angle, the linear velocity along the coordinate direction, and the angular velocity of the corresponding turning angle of the quadrotor UAV that are acquired in real time to the attitude planner-containing position and attitude control model for the quadrotor UAV, thereby obtaining an attitude planner-containing tracking control result for the quadrotor UAV.

### Embodiment 3

An electronic device is provided in Embodiment 3 of the present disclosure. The electronic device includes a memory and a processor. The memory is configured to store a computer program. The processor is configured to run the computer program to enable the electronic device to execute the attitude planner-containing trajectory tracking control method for a quadrotor UAV in Embodiment 1.

### Embodiment 4

Based on the descriptions in Embodiment 3, a storage medium is provided in Embodiment 4 of the present disclosure. The storage medium stores a computer program. The program can be executed by a processor to realize the attitude planner-containing trajectory tracking control method for a quadrotor UAV in Embodiment 1.

Each embodiment in the description is described in a progressive mode, each embodiment focuses on differences from other embodiments, and references can be made to each other for the same and similar parts between embodiments. Since the system disclosed in an embodiment corresponds to the method disclosed in an embodiment, the description is relatively simple, and for related contents, references can be made to the description of the method.

Particular examples are used herein for illustration of principles and implementation modes of the present disclosure. The descriptions of the above embodiments are merely used for assisting in understanding the method of the present disclosure and its core ideas. In addition, those of ordinary skill in the art can make various modifications in terms of particular implementation modes and the scope of application in accordance with the ideas of the present disclosure. In conclusion, the content of the description shall not be construed as limitations to the present disclosure.

1-18. (canceled)

19. An attitude planner-containing trajectory tracking control method for a quadrotor unmanned aerial vehicle (UAV), comprising:
acquiring a historical dataset of a barycentric coordinate, a historical dataset of a yaw angle, a historical dataset of a pitch angle, a historical dataset of a roll angle, a historical dataset of a linear velocity along a coordinate direction, and a historical dataset of an angular velocity of a corresponding turning angle of the quadrotor UAV;
acquiring the barycentric coordinate, the yaw angle, the pitch angle, the roll angle, the linear velocity along the coordinate direction, and the angular velocity of the corresponding turning angle of the quadrotor UAV in real time;
performing kinematic calculation based on the historical dataset of the barycentric coordinate, the historical dataset of the yaw angle, the historical dataset of the pitch angle, the historical dataset of the roll angle, the historical dataset of the linear velocity along the coordinate direction, and the historical dataset of the angular velocity of the corresponding turning angle of the quadrotor UAV, mechanical calculation on four propellers, and mechanical calculation on a body, and calculating an attitude quaternion to obtain a quaternion-based quadrotor UAV dynamic model;
designing a desired fully-actuated force control, and calculating a main thrust direction of a body-fixed frame and a desired thrust direction of an inertial frame according to the desired fully-actuated force control to construct a relative quaternion;
constructing a smooth attitude planner based on the relative quaternion;
determining an attitude error quaternion and an angular velocity error quaternion based on the smooth attitude planner;
calculating an attitude error of the quadrotor UAV based on the attitude error quaternion and the angular velocity error quaternion with a Rodrigues parameter;
determining an outer-loop position control design result and an inner-loop attitude control design result based on the attitude error of the quadrotor UAV;
constructing an attitude planner-containing position and attitude control model for the quadrotor UAV according to the outer-loop position control design result and the inner-loop attitude control design result; and
inputting the barycentric coordinate, the yaw angle, the pitch angle, the roll angle, the linear velocity along the coordinate direction, and the angular velocity of the corresponding turning angle of the quadrotor UAV that are acquired in real time to the attitude planner-containing position and attitude control model for the quadrotor UAV, thereby obtaining an attitude planner-containing tracking control result for the quadrotor UAV.

20. The attitude planner-containing trajectory tracking control method for a quadrotor UAV according to claim 19, wherein the quaternion-based quadrotor UAV dynamic model is expressed as:
$$\dot{r} = v$$
$$m \dot{v} = Fq ⊗ {e}_{3} ⊗ {q}^{- 1} - {mge}_{3} + {d}_{p}$$
$$\dot{q} = \frac{1}{2} q ⊗ \overline{ω}$$
$$J \dot{ω} = - ω \times J ω + τ + {d}_{a}$$
wherein, r=(x, y, z)^{T} and ν respectively represent a position and a velocity of the quadrotor UAV, q=(q₁, q₂, q₃, q₄)=(η,ε^{T}) represents an attitude unit quaternion calculated through an Euler angle, η∈ [symbol] and ε∈ [symbol] ³ being respectively a scalar and a vector of the quaternion, and R representing a set of all real numbers, m∈ [symbol] represents a mass, g represents an acceleration of gravity, F∈ [symbol] and τ=(τₓ, τ_{y}, τ_{z})^{T}∈ [symbol] ³ respectively represent a lift force and a torque obtained by the four propellers, e₃=(0, 0, 1)^{T} is a unit vector in an axis z of the inertial frame, J∈ [symbol] ³× [symbol] ³ is a body-fixed inertial matrix, ω∈S²={x∈ [symbol] ³|x^{T}x=1} represents a rotational angular velocity, ω̅=(0,ω^{T})^{T} is an angular velocity quaternion, dₚ and dₐ respectively represent an uncertain disturbance on a translation system and an uncertain disturbance on a rotation system, comprising a resistance and a wind turbulence, \dot{r} is a first derivative of r, \dot{ν} is a first derivative of ν, \dot{q} is a first derivative of q, \dot{ω} is a first derivative of ω, and q⁻¹ is an inverse of q.

21. The attitude planner-containing trajectory tracking control method for a quadrotor UAV according to claim 19, wherein the desired fully-actuated control is expressed as:
$${μ}_{d} = {mge}_{3} + m {\ddot{r}}_{*} - ( {c}_{2} + \frac{8}{{d}_{1}} + {c}_{1} m ) {v}_{e} + {c}_{1}^{2} {mr}_{e}$$
wherein, μ_{d} represents the desired fully-actuated control, m∈ [symbol] represents a mass, [symbol] being a set of all real numbers, g represents an acceleration of gravity, e₃ represents a unit vector in an axis z of the inertial frame, \ddot{r}_{*} is a second derivative of r_{*}, r_{*} represents a reference trajectory, c₂,d₁ and c₁ each are a positive design parameter, rₑ represents a trajectory tracking error, and νₑ represents a translational velocity error.

22. The attitude planner-containing trajectory tracking control method for a quadrotor UAV according to claim 19, wherein the constructing a smooth attitude planner based on the relative quaternion specifically comprises the following steps:
performing quaternion square-root extraction based on the desired fully-actuated control, and performing desired attitude operation in combination with a yaw angle quaternion q_{Ψ} to obtain a desired attitude quaternion q_{d};
performing attitude error operation on a real-time attitude quaternion q and the desired attitude quaternion q_{d} to obtain an attitude error quaternion qₑ and a Rodrigues parameter attitude error ρₑ;
performing desired attitude derivation on the desired attitude quaternion q_{d}, and performing angular velocity error calculation in combination with the attitude error quaternion qₑ and a real-time rotational angular velocity ω to obtain a rotational angular velocity error ωₑ and transformation data ωₚ of a desired rotational angular velocity ω_{d}; and
performing rotation matrix calculation on the attitude quaternion q to obtain a rotation matrix R.

23. The attitude planner-containing trajectory tracking control method for a quadrotor UAV according to claim 19, wherein the inner-loop attitude control design result is expressed as:
$$τ = - {c}_{4} {ω}_{z} + J ( {\dot{ω}}_{α} + {\dot{ω}}_{p} ) + ω \times J ω - {Φ}^{T} {ρ}_{e}$$
wherein, c₄ represents a positive design parameter, ω_{z} represents an angular velocity error, J represents a body-fixed inertial matrix, \dot{ω}_{α} represents a first derivative of an angular velocity stabilization function, \dot{ω}ₚ represents a first derivative of a desired angular velocity based on a quaternion description, ω represents an angular velocity, Φ^{T} represents a rotation matrix based on the Rodrigues parameter, and ρₑ represents an attitude error based on the Rodrigues parameter.

24. An attitude planner-containing trajectory tracking control system for a quadrotor unmanned aerial vehicle (UAV), comprising:
a first dataset acquisition module configured to acquire a historical dataset of a barycentric coordinate, a historical dataset of a yaw angle, a historical dataset of a pitch angle, a historical dataset of a roll angle, a historical dataset of a linear velocity along a coordinate direction, and a historical dataset of an angular velocity of a corresponding turning angle of the quadrotor UAV;
a second dataset acquisition module configured to acquire the barycentric coordinate, the yaw angle, the pitch angle, the roll angle, the linear velocity along the coordinate direction, and the angular velocity of the corresponding turning angle of the quadrotor UAV in real time;
a quaternion-based quadrotor UAV dynamic model construction module configured to perform kinematic calculation based on the historical dataset of the barycentric coordinate, the historical dataset of the yaw angle, the historical dataset of the pitch angle, the historical dataset of the roll angle, the historical dataset of the linear velocity along the coordinate direction, and the historical dataset of the angular velocity of the corresponding turning angle of the quadrotor UAV, mechanical calculation on four propellers, and mechanical calculation on a body, and calculate an attitude quaternion to obtain a quaternion-based quadrotor UAV dynamic model;
a relative quaternion construction module configured to design a desired fully-actuated force control, and calculate a main thrust direction of a body-fixed frame and a desired thrust direction of an inertial frame according to the desired fully-actuated force control to construct a relative quaternion;
a smooth attitude planner construction module configured to construct a smooth attitude planner based on the relative quaternion;
an attitude error quaternion and angular velocity error quaternion determining module configured to determine an attitude error quaternion and an angular velocity error quaternion based on the smooth attitude planner;
a quadrotor UAV attitude error calculation module configured to calculate an attitude error of the quadrotor UAV based on the attitude error quaternion and the angular velocity error quaternion with a Rodrigues parameter;
an outer-loop design result and an inner-loop design result determining module configured to determine an outer-loop position control design result and an inner-loop attitude control design result based on the attitude error of the quadrotor UAV;
a quadrotor UAV position and attitude control model construction module configured to construct an attitude planner-containing position and attitude control model for the quadrotor UAV according to the outer-loop position control design result and the inner-loop attitude control design result; and
a tracking control result determining module configured to input the barycentric coordinate, the yaw angle, the pitch angle, the roll angle, the linear velocity along the coordinate direction, and the angular velocity of the corresponding turning angle of the quadrotor UAV that are acquired in real time to the attitude planner-containing position and attitude control model for the quadrotor UAV, thereby obtaining an attitude planner-containing tracking control result for the quadrotor UAV.

25. The attitude planner-containing trajectory tracking control system for a quadrotor UAV according to claim 24, wherein
the quaternion-based quadrotor UAV dynamic model is expressed as:
$$\dot{r} = v$$
$$m \dot{v} = Fq ⊗ {e}_{3} ⊗ {q}^{- 1} - {mge}_{3} + {d}_{p}$$
$$\dot{q} = \frac{1}{2} q ⊗ \overline{ω}$$
$$J \dot{ω} = - ω \times J ω + τ + {d}_{a}$$
wherein, r=(x, y, z)^{T} and ν respectively represent a position and a velocity of the quadrotor UAV, q=(q₁, q₂, q₃, q₄)=(η,ε^{T}) represents an attitude unit quaternion calculated through an Euler angle, η∈ [symbol] and ε∈ [symbol] ³ being respectively a scalar and a vector of the quaternion, and R representing a set of all real numbers, m∈ [symbol] represents a mass, g represents an acceleration of gravity, F∈ [symbol] and τ=(τₓ, τ_{y}, τ_{z})^{T} ∈ [symbol] ³ respectively represent a lift force and a torque obtained by the four propellers, e₃=(0, 0, 1)^{T} is a unit vector in an axis z of the inertial frame, J∈ [symbol] ³× [symbol] ³ is a body-fixed inertial matrix, ω∈S²={x∈ [symbol] ³|x^{T}x=1} represents a rotational angular velocity, ω̅=(0,ω^{T})^{T} is an angular velocity quaternion, dₚ and dₐ respectively represent an uncertain disturbance on a translation system and an uncertain disturbance on a rotation system, comprising a resistance and a wind turbulence, r is a first derivative of r, \dot{ν} is a first derivative of ν, \dot{q} is a first derivative of q, \dot{ω} is a first derivative of ω, and q⁻¹ is an inverse of q.

26. The attitude planner-containing trajectory tracking control system for a quadrotor UAV according to claim 24, wherein
the desired fully-actuated control is expressed as:
$${μ}_{d} = {mge}_{3} + m {\ddot{r}}_{*} - ( {c}_{2} + \frac{8}{{d}_{1}} + {c}_{1} m ) {v}_{e} + {c}_{1}^{2} {mr}_{e}$$
wherein, μ_{d} represents the desired fully-actuated control, m∈ [symbol] represents a mass, [symbol] being a set of all real numbers, g represents an acceleration of gravity, e₃ represents a unit vector in an axis z of the inertial frame, \ddot{r}_{*} is a second derivative of r_{*}, r_{*} represents a reference trajectory, c₂,d₁ and c₁ each are a positive design parameter, rₑ represents a trajectory tracking error, and νₑ represents a translational velocity error.

27. An electronic device, comprising a memory and a processor, wherein the memory is configured to store a computer program, and the processor is configured to run the computer program to enable the electronic device to execute the attitude planner-containing trajectory tracking control method for a quadrotor UAV according to claim 19.

28. Anon-transitory computer-readable storage medium, wherein the computer-readable storage medium stores a computer program, and the computer program is executed by a processor to realize the attitude planner-containing trajectory tracking control method for a quadrotor UAV according to claim 19.

29. The electronic device according to claim 27, wherein the quaternion-based quadrotor UAV dynamic model is expressed as:
$$\dot{r} = v$$
$$m \dot{v} = Fq ⊗ {e}_{3} ⊗ {q}^{- 1} - {mge}_{3} + {d}_{p}$$
$$\dot{q} = \frac{1}{2} q ⊗ \overline{ω}$$
$$J \dot{ω} = - ω \times J ω + τ + {d}_{a}$$
wherein, r=(x, y, z)^{T} and ν respectively represent a position and a velocity of the quadrotor UAV, (q₁, q₂, q₃, q₄)=(η,ε^{T}) represents an attitude unit quaternion calculated through an Euler angle, η∈ [symbol] and ε∈ [symbol] ³ being respectively a scalar and a vector of the quaternion, and [symbol] representing a set of all real numbers, m∈ [symbol] represents a mass, g represents an acceleration of gravity, F∈ [symbol] and τ=(τₓ, τ_{y}, τz)^{T} ∈ [symbol] ³ respectively represent a lift force and a torque obtained by the four propellers, e₃=(0, 0, 1)^{T}, is a unit vector in an axis z of the inertial frame, J∈ [symbol] ³× [symbol] ³ is a body-fixed inertial matrix, ω∈S²={x∈ [symbol] ³|x^{T}x=1} represents a rotational angular velocity, ω̅=(0,ω^{T})^{T} is an angular velocity quaternion, dₚ and dₐ respectively represent an uncertain disturbance on a translation system and an uncertain disturbance on a rotation system, comprising a resistance and a wind turbulence, r is a first derivative of r, \dot{ν} is a first derivative of ν, \dot{q} is a first derivative of q, \dot{ω} is a first derivative of aw, and q⁻¹ is an inverse of q.

30. The electronic device according to claim 27, wherein the desired fully-actuated control is expressed as:
$${μ}_{d} = {mge}_{3} + m {\ddot{r}}_{*} - ( {c}_{2} + \frac{8}{{d}_{1}} + {c}_{1} m ) {v}_{e} + {c}_{1}^{2} {mr}_{e}$$
wherein, μ_{d} represents the desired fully-actuated control, m∈ [symbol] represents a mass, [symbol] being a set of all real numbers, g represents an acceleration of gravity, e₃ represents a unit vector in an axis z of the inertial frame, \ddot{r}_{*} is a second derivative of r_{*}, r_{*} represents a reference trajectory, c₂,d₁ and c₁ each are a positive design parameter, rₑ represents a trajectory tracking error, and νₑ represents a translational velocity error.

31. The electronic device according to claim 27, wherein the constructing a smooth attitude planner based on the relative quaternion specifically comprises the following steps:
performing quaternion square-root extraction based on the desired fully-actuated control, and performing desired attitude operation in combination with a yaw angle quaternion q_{Ψ} to obtain a desired attitude quaternion q_{d};
performing attitude error operation on a real-time attitude quaternion q and the desired attitude quaternion q_{d} to obtain an attitude error quaternion qₑ and a Rodrigues parameter attitude error ρₑ;
performing desired attitude derivation on the desired attitude quaternion q_{d}, and performing angular velocity error calculation in combination with the attitude error quaternion qₑ and a real-time rotational angular velocity ω to obtain a rotational angular velocity error ωₑ and transformation data ω of a desired rotational angular velocity ω_{d}; and
performing rotation matrix calculation on the attitude quaternion q to obtain a rotation matrix R.

32. The electronic device according to claim 27, wherein the inner-loop attitude control design result is expressed as:
$$τ = - {c}_{4} {ω}_{z} + J ( {\dot{ω}}_{α} + {\dot{ω}}_{p} ) + ω \times J ω - {Φ}^{T} {ρ}_{e}$$
wherein, c₄ represents a positive design parameter, ω_{Z} represents an angular velocity error, J represents a body-fixed inertial matrix, \dot{ω}_{α} represents a first derivative of an angular velocity stabilization function, \dot{ω}ₚ represents a first derivative of a desired angular velocity based on a quaternion description, ω represents an angular velocity, Φ^{T} represents a rotation matrix based on the Rodrigues parameter, and ρₑ represents an attitude error based on the Rodrigues parameter.

33. The non-transitory computer-readable storage medium according to claim 28, wherein the quaternion-based quadrotor UAV dynamic model is expressed as:
$$\dot{r} = v$$
$$m \dot{v} = Fq ⊗ {e}_{3} ⊗ {q}^{- 1} - {mge}_{3} + {d}_{p}$$
$$\dot{q} = \frac{1}{2} q ⊗ \overline{ω}$$
$$J \dot{ω} = - ω \times J ω + τ + {d}_{a}$$
wherein, r=(x, y, z)^{T} and ν respectively represent a position and a velocity of the quadrotor UAV, q (q₁, q₂, q₃, q₄)=(η,ε^{T}) represents an attitude unit quaternion calculated through an Euler angle, η∈ [symbol] and ε∈ [symbol] ³ being respectively a scalar and a vector of the quaternion, and R representing a set of all real numbers, m∈ [symbol] represents a mass, g represents an acceleration of gravity, F∈ [symbol] and τ=(τₓ, τ_{y}, τ_{z})^{T}∈ [symbol] ³ respectively represent a lift force and a torque obtained by the four propellers, e₃=(0, 0, 1)^{T} is a unit vector in an axis z of the inertial frame, J∈ [symbol] ³× [symbol] ³ is a body-fixed inertial matrix, ω∈S²={x∈ [symbol] ³|x^{T}x=1} represents a rotational angular velocity, is an angular velocity quaternion, dₚ and dₐ respectively represent an uncertain disturbance on a translation system and an uncertain disturbance on a rotation system, comprising a resistance and a wind turbulence, \dot{r} \dot{ } is a first derivative of r, \dot{ν} is a first derivative of ν, \dot{q} is a first derivative of q, \dot{ω} is a first derivative of ω, and q⁻¹ is an inverse of q.

34. The non-transitory computer-readable storage medium according to claim 28, wherein the desired fully-actuated control is expressed as:
$${μ}_{d} = {mge}_{3} + m {\ddot{r}}_{*} - ( {c}_{2} + \frac{8}{{d}_{1}} + {c}_{1} m ) {v}_{e} + {c}_{1}^{2} {mr}_{e}$$
wherein, μ_{d} represents the desired fully-actuated control, m∈ [symbol] represents a mass, [symbol] being a set of all real numbers, g represents an acceleration of gravity, e₃ represents a unit vector in an axis z of the inertial frame, \ddot{r}_{*} is a second derivative of r_{*}, r_{*} represents a reference trajectory, c₂,d₁ and c₁ each are a positive design parameter, e represents a trajectory tracking error, and e represents a translational velocity error.

35. The non-transitory computer-readable storage medium according to claim 28, wherein the constructing a smooth attitude planner based on the relative quaternion specifically comprises the following steps:
performing quaternion square-root extraction based on the desired fully-actuated control, and performing desired attitude operation in combination with a yaw angle quaternion q_{Ψ} to obtain a desired attitude quaternion q_{d};
performing attitude error operation on a real-time attitude quaternion q and the desired attitude quaternion q_{d} to obtain an attitude error quaternion qₑ and a Rodrigues parameter attitude error ρₑ;
performing desired attitude derivation on the desired attitude quaternion q_{d}, and performing angular velocity error calculation in combination with the attitude error quaternion qₑ and a real-time rotational angular velocity ω to obtain a rotational angular velocity error ωₑ and transformation data ωₚ of a desired rotational angular velocity ω_{d}; and
performing rotation matrix calculation on the attitude quaternion q to obtain a rotation matrix R.

36. The non-transitory computer-readable storage medium according to claim 28, wherein the inner-loop attitude control design result is expressed as:
$$τ = - {c}_{4} {ω}_{z} + J ( {\dot{ω}}_{α} + {\dot{ω}}_{p} ) + ω \times J ω - {Φ}^{T} {ρ}_{e}$$
wherein, c₄ represents a positive design parameter, ω_{Z} represents an angular velocity error, J represents a body-fixed inertial matrix, \dot{ω}_{α} represents a first derivative of an angular velocity stabilization function, \dot{ω}ₚ represents a first derivative of a desired angular velocity based on a quaternion description, ω represents an angular velocity, Φ^{T} represents a rotation matrix based on the Rodrigues parameter, and ρₑ represents an attitude error based on the Rodrigues parameter.
